(19) United States
(12) Patent Application Publication
(10) Pub. No.: US 2020/0101465 A1
(43) Pub. Date: Apr. 2, 2020

(54) ANALYZER FOR TESTING A SAMPLE

(71) Applicant: BOEHRINGER INGELHEIM VETMEDICA GMBH, Ingelheim am Rhein (DE)

(72) Inventors: Axel NIEMEYER, Bielefeld (DE); Guenter BRUCKMANN, Wuerselen (DE); André FICHTNER, Wildberg (DE); Hendrik HUG, Sindelfingen (DE); Juri KOENIG, Boeblingen (DE); Dagmar STOLPMANN, Boeblingen (DE)

(73) Assignee: BOEHRINGER INGELHEIM VETMEDICA GMBH, Ingelheim am Rhein (DE)

(21) Appl. No.: 16/586,013

(22) Filed: Sep. 27, 2019

(30) Foreign Application Priority Data
Oct. 1, 2018 (EP) 18197843.8

(51) Int. Cl. B01L 9/00

(52) U.S. Cl. CPC B01L 9/50; B01L 2200/025; B01L 2300/0627; B01L 2300/123; B01L 2200/143; B01L 2200/027

(57) ABSTRACT

An analyzer for testing a biological sample, wherein the analyzer has a guide apparatus for guiding a clamping unit and/or a connection unit, wherein the guide apparatus is adapted to compensate misalignments. The analyzer has a rack for the clamping unit and/or connection unit, and wherein the rack is supported by a flexible cushion within a housing of the analyzer.

### BACKGROUND OF THE INVENTION

### Field of the Invention

The present invention relates to an analyzer.

Preferably, the present invention deals with analyzing and testing a preferably biological sample, in particular from a human or animal, mostly preferred for analytics and diagnostics, e.g., with regard to the presence of diseases and/or pathogens and/or for determining blood counts, antibodies, hormones, steroids or the like.

Therefore, the present invention is in particular within the field of bioanalytics. A food sample, environmental sample or another sample may optionally also be tested, in particular for environmental analytics or food safety and/or for detecting other substances.

Preferably, by means of the present invention, at least one analyte (target analyte) of a sample can be determined, identified or detected. In particular, the sample can be tested qualitatively or quantitatively for determining at least one analyte, e.g., in order to detect or identify a disease and/or pathogen.

Within the meaning of the present invention, analytes are in particular nucleic-acid sequences, in particular DNA sequences and/or RNA sequences, and/or proteins, in particular antigens and/or antibodies. In particular, by means of the present invention, nucleic-acid sequences or proteins can be determined, identified or detected as the analytes of a sample. Mostly preferred, the present invention deals with systems, devices and other apparatuses for carrying out a nucleic-acid assay for detecting or identifying a nucleic-acid sequence or a protein assay for detecting or identifying a protein.

The present invention deals in particular with what are known as point-of-care systems, e.g., mobile systems/devices and other mobile apparatuses, and deals with methods for carrying out tests on a sample at the sampling site and/or independently or away from a central laboratory or the like. Preferably, point-of-care systems can be operated autonomously and/or independently of a mains network for supplying electrical power.

### Description of the Related Art

U.S. Pat. No. 5,096,669 discloses a point-of-care system for testing a biological sample, in particular a blood sample. The system comprises a single-use cartridge and an analyzer. Once the sample has been received, the cartridge is inserted into the analyzer in order to carry out the test. The cartridge comprises a microfluidic system and a sensor apparatus comprising electrodes, which apparatus is calibrated by means of a calibration liquid and is then used to test the sample.

Furthermore, International Patent Application Publication WO 2006/125767 A1 and corresponding U.S. Pat. No. 9,110,044 B2 disclose a point-of-care system for integrated and automated DNA or protein analysis, comprising a single-use cartridge and an analyzer for fully automatically processing and evaluating molecular-diagnostic analyses using the single-use cartridge.

International Patent Application Publication WO 2018/065110 A1 and corresponding U.S. Patent Application Publication 2018/0099279 A1 disclose an analyzer and a method for testing a biological sample, wherein the analyzer comprises a receiving unit for receiving, positioning and holding the cartridge and a connection unit for mechanically, electrically, thermally and/or fluidically connecting the cartridge. The receiving unit can be moved relative to the connection unit in order to hold the cartridge in a clamped manner between the receiving unit and the connection unit.

In point-of-care systems, it is important that the analyzers used are constructed in a simple and robust manner and that a simple and reliable sequence of the test can be achieved.

### SUMMARY OF THE INVENTION

The problem addressed by the present invention is to provide an improved analyzer for testing a sample, preferably wherein a simple, robust, cost-effective and/or low maintenance construction and/or a simple and/or reliable sequence of the test is possible or facilitated, in particular under different test conditions.

The problem is solved by an analyzer described herein.

The proposed analyzer preferably comprises a connection unit for mechanically, electrically, thermally and/or fluidically connecting a cartridge to the analyzer and a clamping unit for receiving, positioning/aligning, holding and/or clamping the cartridge, preferably wherein the clamping unit and the connection unit can be moved relative to one another in order to clamp the cartridge between the clamping unit and the connection unit and/or in order to connect the cartridge to the connection unit and/or in order to position/align the cartridge on/relative to the connection unit.

According to one aspect of the present invention, the analyzer comprises a (linear-motion) guide/bearing apparatus for (moveably) guiding the clamping unit and the connection unit relative to one another, wherein the guide apparatus, in particular one guide thereof, is adapted to compensate radial/parallel and/or angular misalignment of the clamping unit, the connection unit and/or the guide apparatus, in particular its rails, mostly preferred relative to one another.

In the context of the present invention, the term “misalignment” is preferably understood to refer to any (unwanted/unplanned) deviation from the intended alignment/position of the (moving) parts/components of the analyzer, in particular the clamping unit, the connection unit and/or the guide apparatus relative to one another. For example, the guides/rails of the guide apparatus and/or the connection unit and/or the clamping unit, in particular the main planes of extension thereof, should be parallel to one another (intended parallel alignment), but might be angular misaligned and, thus, nonparallel.

Misalignment of the clamping unit, the connection unit and/or the guide apparatus might be caused by manufacturing inaccuracy/errors, wear, deflection, different test conditions, thermal expansion of the analyzer or the like and can have a negative impact on the functionality of the analyzer or even lead to malfunction. In particular, misalignment can cause canting/jamming of the (moving) parts/components of the analyzer, in particular the clamping unit, the connection unit and/or the guide apparatus.

Parallel/radial misalignment is preferably a radial/parallel offset/deviation between two parts/axes and/or when the radial distance between two parts/axes (temporarily) deviates, in particular in the horizontal and/or vertical plane/level, from the intended radial distance.

In the context of the present invention, the terms “parallel misalignment” and “radial misalignment” are preferably synonymous/interchangeable.

Angular misalignment is preferably an angular offset/deviation between two parts/axes and/or when the angle enclosed between two parts/axes (temporarily) deviates, in particular in the horizontal and/or vertical plane/level, from the intended angle.

In particular in order to compensate angular and/or radial misalignments and/or to reduce the negative effects thereof, the analyzer, in particular the guide apparatus, preferably comprises a preferably one-sided angular play (tiltability) and/or a preferably one-sided radial, in particular horizontal, play, in particular for the clamping unit and/or the connection unit, and/or allows a preferably one-sided angular movement (tilting) and/or a preferably one-sided radial movement of the clamping unit, the connection unit and/or the guide apparatus, in particular its rails, mostly preferred relative to one another.

Preferably, the guide apparatus comprises at least two (linear-motion) guides/bearings, each preferably having a rail and at least one bush that is moveably attached to the associated rail.

The guides, in particular the rails or the guide axes thereof, on the one hand and the clamping unit and/or the connection unit, in particular the main plane(s) of extension thereof, on the other hand are preferably arranged at least essentially perpendicular to one another and/or are intended to be at least essentially perpendicular to one another (intended alignment).

The clamping unit and the connection unit, in particular the main planes of extension thereof, are preferably arranged at least essentially parallel to one another and/or are intended to be at least essentially parallel (intended alignment).

Preferably, the guide apparatus comprises a first/main rail and a first/main bush and a second/compensation rail and a second/compensation bush, preferably wherein the first rail and the main bush form a first guide of the guide apparatus and the second rail and the second/compensation bush form a second guide of the guide apparatus.

The first guide/rail and the second guide/rail are preferably arranged at least essentially parallel to one another and/or are intended to be at least essentially parallel (intended alignment).

Preferably, at least the second guide and/or its compensation bush comprises an angular play and/or a radial play for the clamping unit and/or the connection unit and/or allows an angular movement and/or a radial movement of the clamping unit, the connection unit and/or the guide apparatus, in particular its second guide/rail, relative to one another.

Mostly preferred, the analyzer, in particular the guide apparatus, allows an angular movement and/or a radial, in particular horizontal, movement of the guides and/or rails relative to one another.

According to a further aspect of the present invention, which can also be realized independently, the guides of the guide apparatus, in particular the bushes, comprise a different radial play and/or angular play and/or allow/provide a different angular and/or radial movement.

Preferably, the tiltability and/or the (radial) play of the second guide, in particular its compensation bush, is greater than the tiltability and/or the (radial) play of the first guide, in particular its main bush.

Mostly preferred, the first/main guide/bush of the guide apparatus is adapted to guide the clamping unit and/or the connection unit at least essentially rigidly/untiltably and/or at least essentially without angular and/or radial play and the second/compensation guide/bush of the guide apparatus is adapted to guide the clamping unit and/or the connection unit loosely/tiltably and/or with an angular and/or radial play.

In particular, only the second guide and/or its compensation bush is adapted to allow a (guided) tilting and/or a (guide) radial movement of the clamping unit and/or connection unit relative to the associated/second rail and/or relative to one another.

In the context of the present invention, the terms “angular play” and “tiltability” are preferably synonymous/interchangeable and/or refer to the ability to allow an angular movement of the guides, rails, clamping unit and/or connection unit relative to one another and/or to vary the angle enclosed by the actuation axis and/or guide axis on the one hand and the main extension plane of the clamping unit and/or connection unit on the other hand, in particular at least within a predefined range.

Due to the tiltability/the angular play, angular misalignment can be compensated.

In the context of the present invention, the term “radial play” is preferably understood to refer to the ability to allow radial movement of the guides, rails, clamping unit and/or connection unit relative to one another and/or to vary the radial distances, in particular between the guides, rails and/or the guide axes, in particular at least within a predefined range.

Due to the radial play radial/parallel misalignment can be compensated.

In the context of the present invention, radial movement is preferably understood to refer to a movement transverse/perpendicular to the actuation and/or guiding movement/direction of the guide apparatus, the actuation axis and/or the guide axes.

Preferably, the compensation bush is embodied as a spherical bearing and/or comprises a (convex) inner part and corresponding (concave) outer part, preferably wherein the inner part and the outer part are tiltable and/or angular rotatable/movable relative to one another and/or wherein the outer part is (rigidly) attached to the clamping unit and/or connection unit and/or wherein the inner part is tiltably held within the outer part and/or (directly) mounted/guided on the associated rail (second rail).

Due to the guide apparatus, in particular its compensation bush, it is possible to compensate misalignments of the moving parts of the analyzer and/or to prevent or minimize the risk of clamping/canting of the moving parts of the analyzer.

Preferably, the first guide, the first rail and/or the main bush are/is longer and/or thicker and/or comprises less play/clearance than the second guide, the second rail and/or the compensation bush. With other words, some or all guides/bushes of the guide apparatus differ from one another with regard to their construction and/or functionality.

Preferably, the main bush is embodied as a (rigid) cylindrical (plane) bush and/or is immovably attached to the clamping unit or connection unit, preferably wherein the main bush extends out of the clamping unit or connection unit.

Due to the combination of the first guide, in particular the main bush, and the second guide, in particular the compensation bush, it is possible to precisely move the clamping unit and connection unit relative to one another and, nevertheless, to reduce the risk of clamping/canting of the moving parts. Further, the requirements concerning the tolerances and, thus, the costs of the analyzer are reduced.

According to a further aspect of the present invention, which can also be implemented independently, the analyzer, in particular the clamping unit, mostly preferred an actuation apparatus thereof, comprises at least one, in particular a plurality of, (passive) actuators, wherein the actuators are—in particular axially and/or partially and/or individually and/or independently from one another—compressible/elastic/flexible.

Mostly preferred, each of the actuators, in particular each actuation element thereof, is spring mounted and/or flexible in and/or transverse to the direction of actuation.

Preferably, the actuators are embodied as flexible/spring mounted pins that protrude out of the clamping unit, in particular in order mechanically interact with the cartridge, mostly preferred through an intermediate unit arranged between the clamping unit and the cartridge.

Due to the flexibility of the actuators it is possible to compensate misalignments between the cartridge and the clamping unit, in particular its actuators, and/or to limit the force exerted by the clamping unit or its actuators on the cartridge.

According to a further aspect of the present invention, which can also be realized independently, the analyzer comprises a housing and/or a preferably rigid and/or frame-like rack for holding the clamping unit, the connection unit and/or the guide apparatus, wherein the rack is mounted in the housing in a screwless-manner and/or wherein the rack is supported/held by a preferably flexible cushion within the housing.

Mostly preferred, the cushion is at least partially made of foam.

Thus, the cushion preferably serves as a damper and/or absorbs forces/vibrations. Both, inner forces/vibration, e.g., causes by the moving parts of the analyzer, and outer forces/vibration, e.g., caused by a hit/stroke on the housing, are minimized and/or at least partially absorbed by means of the cushion. In this way, damages of the analyzer or (negative) impacts on the test are prevented or at least minimized, e.g., when the analyzer is subjected to an impact.

With other words, the cushion acts as a buffer and/or a crumble/deformable zone between the housing and the inner parts of the analyzer, in particular the rack, the connection unit, the clamping unit, the guide apparatus and/or the cartridge.

Further, the assembly, disassembly and/or maintenance of the analyzer is facilitated, as the cushion, the rack and the housing are mounted in a screwless-manner This allows a simple and robust construction of the analyzer that is easy to maintain.

In the context of the present invention, the term “analyzer” is preferably understood to refer to a preferably mobile instrument/apparatus, which is designed to chemically, biologically and/or physically tests and/or analyze a sample or a component thereof, preferably in and/or by means of a cartridge containing the sample. The analyzer preferably controls the testing of the sample in and/or by means of the cartridge. In order to carry out the test, the cartridge can be connected to, in particular received by, the analyzer, as already mentioned.

The term “cartridge” is preferably understood to refer to an in particular disposable apparatus or unit which is designed to receive, to store and/or to physically, chemically and/or biologically treat and/or prepare and/or to measure a sample, preferably in order to detect, identify or determine at least one analyte, in particular a protein and/or nucleic-acid sequence, of the sample.

A cartridge within the meaning of the present invention preferably comprises a fluid system having a plurality of channels, cavities and/or valves for controlling the flow through the channels and/or cavities. In particular, a cartridge is at least substantially planar and/or card-like. Mostly preferred, a cartridge is designed as a (micro)fluidic card and/or as a support/container that can be closed and/or inserted and/or plugged in an analyzer when it contains a sample.

The above-mentioned aspects and features of the present invention and the aspects and features of the present invention that will become apparent from the following description can, in principle, be implemented independently from one another, but also in any combination or order.

Other aspects, advantages, features and properties of the present invention will become apparent from the following description of a preferred embodiment with reference to the accompanying drawings.

### BRIEF DESCRIPTION OF THE DRAWINGS

FIG. 1 is a schematic view of a proposed analyzer and a cartridge received therein;

FIG. 2 is a schematic perspective front view of the cartridge;

FIG. 3 is a schematic perspective rear view of the cartridge;

FIG. 4 is a schematic perspective view of the analyzer in an open state;

FIG. 5 is an exploded view of the analyzer;

FIG. 6 is a schematic perspective view of a clamping system of the analyzer;

FIG. 7 is a top view of the clamping system of the analyzer according to FIG. 6;

FIG. 8 is a schematic section along the line VIII-VIII shown in FIG. 7;

FIG. 9A is a schematic section along the line IX-IX shown in FIG. 7;

FIG. 9B is a schematic section along the main plane of a clamping unit of the analyzer;

FIG. 10 is a schematic sectional view of the analyzer, showing the analyzer in the open position;

FIG. 11 is a schematic sectional view of the analyzer, showing the analyzer in the closed position with an inserted cartridge;

FIG. 12 is a schematic sectional view of the analyzer, showing the analyzer in a clamping position;

FIG. 13 is a schematic sectional view of the analyzer, showing the analyzer in the actuated position;

FIG. 14 is a schematic sectional view of the analyzer, showing the analyzer in the test position;

FIG. 15 is a schematic perspective view of an actuation apparatus having a plurality of actuators for actuating valves on the cartridge;

FIG. 16 is a schematic section of the actuation apparatus along the line XVI-XVI shown in FIG. 15;

FIG. 17 is a schematic perspective view of an intermediate unit of the analyzer; and

FIG. 18 is a schematic perspective view of a connection unit of the analyzer.

### DETAILED DESCRIPTION OF THE INVENTION

In the Figures, the same reference signs are used for the same or similar parts and components, resulting in corresponding or comparable properties, features and advantages, even if these are not repeatedly described.

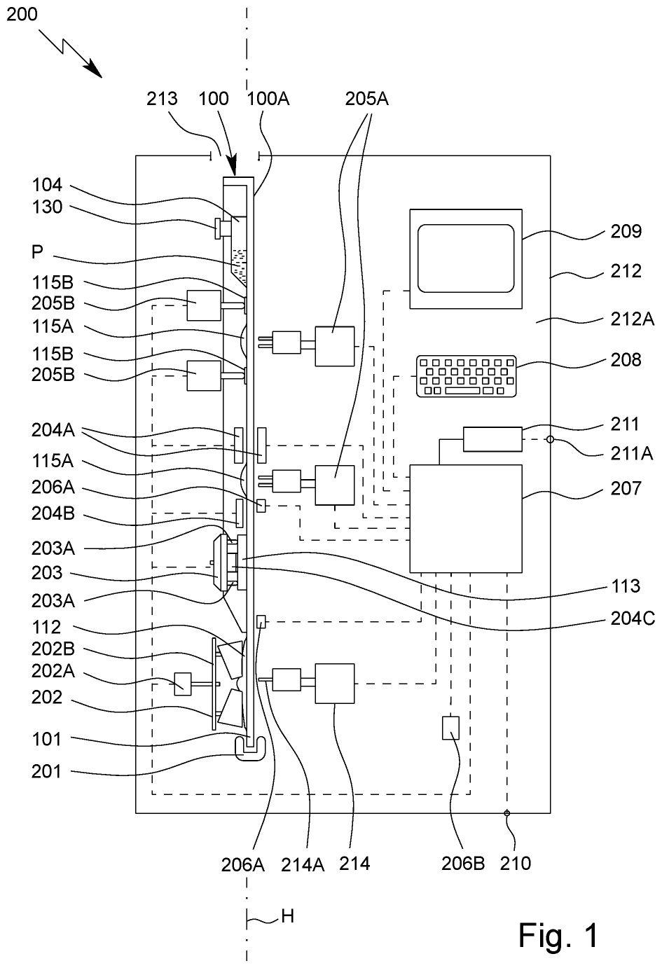

FIG. 1 is a highly schematic view of a proposed analyzer 200 comprising an apparatus or cartridge 100 for testing, in particular, a biological sample P.

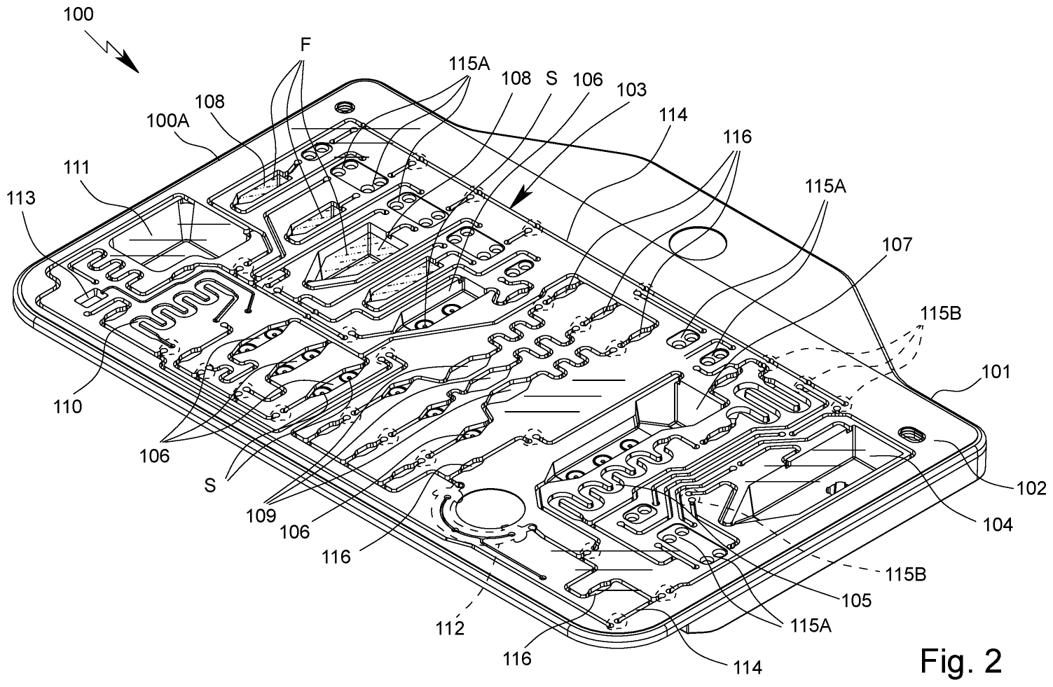

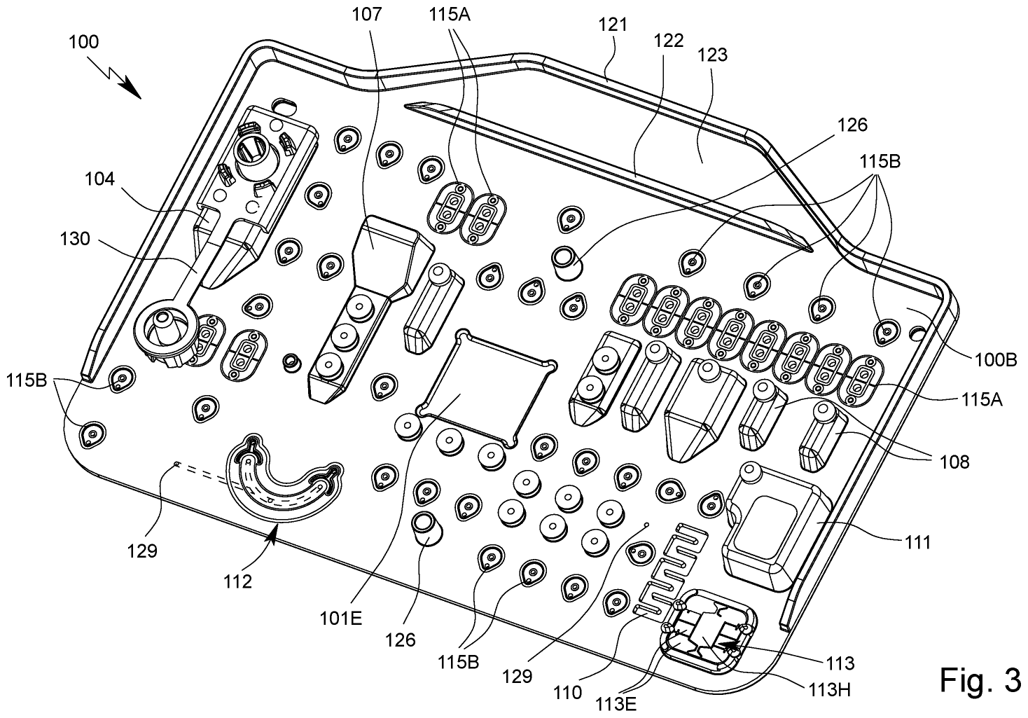

FIG. 2 is a perspective front view of the cartridge 100 showing its front 100A, and FIG. 3 is a perspective rear view thereof, showing its back 100B.

The apparatus or cartridge 100 in particular forms a handheld unit, hereinafter referred to as cartridge 100.

The term “sample” is preferably understood to refer to a sample material that is to be tested and which is in particular taken from a human or animal. Preferably, within the meaning of the present invention, a sample is a fluid, such as saliva, blood, urine or another liquid, preferably from a human or animal, or a component thereof.

Within the meaning of the present invention, a sample may be pre-treated or prepared if necessary, or may come directly from a human or animal or the like. A food sample, environmental sample or another sample may optionally also be tested, in particular for environmental analytics, food safety and/or for detecting other substances, preferably natural substances, but also biological or chemical warfare agents, poisons or the like.

A sample within the meaning of the present invention preferably contains one or more analytes, it preferably being possible for the analytes to be identified or detected, in particular qualitatively and/or quantitatively determined. Preferably, within the meaning of the present invention, a sample has target nucleic-acid sequences as analytes, in particular target DNA sequences and/or target RNA sequences, and/or target proteins as the analytes, in particular target antigens and/or target antibodies. Preferably, at least one disease and/or pathogen can be detected or identified in the sample P by qualitatively and/or quantitatively determining the analytes.

Preferably, the analyzer 200 controls the testing of the sample P, in particular in or on the cartridge 100, and/or is used to evaluate the testing and/or to collect, to process and/or to store measured values from the test.

By means of the analyzer 200 and/or by means of the cartridge 100 and/or by means of the method for testing the sample P, an analyte or a plurality of analytes of the sample P can preferably be determined, identified or detected, in particular not only qualitatively, but also quantitatively.

Therefore, the sample P can in particular be tested qualitatively and/or quantitatively for determining at least one analyte, e.g., in order to detect or identify a disease and/or a pathogen or to determine other values, which are important for diagnostics, for example.

The cartridge 100 is preferably at least substantially planar, flat, plate-shaped and/or card-like.

The cartridge 100 preferably comprises an in particular at least substantially planar, flat, plate-shaped and/or card-like main body/support 101, the main body or support 101 in particular being made of and/or injection-molded from plastic material, in particular polypropylene.

The cartridge 100 preferably comprises two flat sides 100A, 100B. In particular, the front 100A of the cartridge 100 and the back 100B of the cartridge 100 are each a flat side of the in particular planar and/or card-like cartridge 100.

The cartridge 100 preferably comprises at least one film/cover 102 for covering the main body 101 and/or cavities and/or channels formed therein, at least partially, in particular on the front 100A, and/or for forming valves or the like.

The cartridge 100 and/or its main body 101, in particular together with the cover 102, preferably forms and/or comprises a fluidic system 103, hereinafter referred to as fluid system 103.

The cartridge 100, the main body 101 and/or the fluid system 103 are/is preferably at least substantially vertically oriented during the operation/test and/or in the test/operating position and/or when being inserted in the analyzer 200, as shown schematically in FIG. 1. In particular, the surface extension or main plane H of the cartridge 100 extends at least substantially vertically in the test/operating position.

The cartridge 100, in particular its fluid system 103, preferably comprises a plurality of cavities, in particular at least one receiving cavity 104 for receiving/introducing the sample P, at least one metering cavity 105, at least one intermediate cavity 106, at least one mixing cavity 107, at least one storage cavity 108, at least one reaction cavity 109, at least one intermediate temperature-control cavity 110 and/or at least one collection cavity 111, a plurality of cavities preferably being fluidically interconnected in particular by a plurality of channels.

Within the meaning of the present invention, channels are preferably elongate forms for conducting a fluid in a main flow direction, the forms preferably being closed transversely, in particular perpendicularly, to the main flow direction and/or longitudinal extension, preferably on all sides.

In particular, the main body 101 comprises elongate notches, recesses, depressions or the like, which are closed at the side by the cover 102 and form channels within the meaning of the present invention.

Within the meaning of the present invention, cavities or chambers are preferably formed by recesses, depressions or the like in the cartridge 100 or main body 101, which are closed or covered by the cover 102, in particular at the side. The volume or space enclosed by each cavity is preferably fluidically linked, in particular to the fluid system 103, by means of channels.

In particular, within the meaning of the present invention, a cavity comprises at least two openings for the inflow and/or outflow of fluids.

Within the meaning of the present invention, cavities preferably have a larger diameter and/or flow cross section than channels, preferably by at least a factor of 2, 3 or 4. In principle, however, cavities may in some cases also be elongate, in a similar manner to channels.

The cartridge 100 and/or the fluid system 103 preferably comprises at least one pump apparatus 112 and/or at least one sensor arrangement/apparatus 113.

In the example shown, the cartridge 100 or the fluid system 103 preferably comprises a plurality of intermediate cavities 106, a plurality of storage cavities 108 and/or a plurality of reaction cavities 109, which can preferably be loaded separately from one another.

In the initial state of the cartridge 100 or when at the factory, the storage cavities 108 are preferably filled at least in part, in particular with a liquid such as a reagent, solvent or wash buffer.

The reaction cavity/cavities 109 is/are preferably designed to allow a substance located in the reaction cavity 109 to react when an assay is being carried out.

The reaction cavity/cavities 109 is/are used in particular to carry out an amplification reaction, in particular PCR, or several, preferably different, amplification reactions, in particular PCRs. It is preferable to carry out several, preferably different, PCRs, i.e. PCRs having different primer combinations or primer pairs, in parallel and/or independently and/or in different reaction cavities 109.

“PCR” stands for polymerase chain reaction and is a molecular-biological method by means of which certain analytes, in particular portions of RNA or RNA sequences or DNA or DNA sequences, of a sample P are amplified, preferably in several cycles, using polymerases or enzymes, in particular in order to subsequently test and/or detect the amplification products or nucleic-acid products. If RNA is intended to be tested and/or amplified, before the PCR is carried out, a cDNA is produced starting from the RNA, in particular using reverse transcriptase. The cDNA is used as a template for the subsequent PCR.

The amplification products, target nucleic-acid sequences and/or other portions of the sample P produced in one or more reaction cavities 109 can be conducted or fed to the connected sensor arrangement or sensor apparatus 113, in particular by means of the pump apparatus 112.

The sensor arrangement or sensor apparatus 113 is used in particular for detecting, particularly preferably qualitatively and/or quantitatively determining, the analyte or analytes of the sample P, mostly preferred the target nucleic-acid sequences and/or target proteins as the analytes. Alternatively or additionally, however, other values may also be collected and/or determined.

The sensor apparatus 113 preferably comprises a sensor array (not shown) in order to determine or detect in particular a plurality of analytes.

In particular, the sensor apparatus 113 or sensor array comprises capture molecules (not shown) in order to bond analytes and/or amplification products and subsequently detect, identify or determine said analytes and/or amplification products in a detection process.

Mostly preferred, electrochemical detection is carried out.

The cartridge 100, the main body 101 and/or the fluid system 103 preferably comprise a plurality of channels 114 and/or valves 115, as shown in FIG. 2.

By means of the channels 114 and/or valves 115, the cavities 104 to 111, the pump apparatus 112 and/or the sensor apparatus 113 can be temporarily and/or permanently fluidically interconnected and/or fluidically separated from one another, as required and/or optionally or selectively, in particular such that they are controlled by the analyzer 200.

The cavities 104 to 111 are preferably each fluidically linked or interconnected by a plurality of channels 114. In particular, each cavity is linked or connected by at least two associated channels 114, such that the fluid can fill, flow through and/or drain from the respective cavities as required.

The fluid transport or the fluid system 103 is preferably not or not exclusively based on capillary forces, but is preferably essentially based on the effects of gravity and/or pumping forces, compressive forces and/or suction forces that arise and/or that are generated by the pump or pump apparatus 112.

Mostly preferred, the flow or transport of fluids and the metering are controlled by accordingly opening and closing the valves 115 and/or by accordingly operating the pump apparatus 112, in particular by means of the analyzer 200, in particular its pump drive 202.

Preferably, at least one valve 115 is assigned to each cavity, the pump apparatus 112 and/or the sensor apparatus 113 and/or is arranged upstream of the respective inlets and/or downstream of the respective outlets.

Preferably, by actuation of the assigned valves 115, the cavities 104 to 111 or sequences of cavities 104 to 111, can be selectively released and/or fluid can selectively flow therethrough, and/or the cavities 104 to 111 can be fluidically connected to the fluid system 103 and/or to other cavities.

In particular, the valves 115 are formed by the main body 101 and the film/cover 102 and/or are formed therewith and/or are formed in another manner, e.g., by additional layers, depressions or the like.

Preferably, one or more valves 115A are—preferably tightly—closed initially and/or in the delivery state of the cartridge 100, in particular in order to seal liquids or liquid reagents F, located in the storage cavities 108, and/or the fluid system 103 from the open receiving cavity 104 and/or in a storage-stable manner Hereinafter, these valves 115A are referred to as initially closed valves 115A.

Preferably, an initially closed valve 115A is arranged upstream and downstream of each storage cavity 108. Said valves 115A are preferably (only) opened, in particular automatically and/or by means of the analyzer 200, when the cartridge 100 is actually being used, in particular for the first time, and/or during or after inserting the cartridge 100 into the analyzer 200 and/or for carrying out the assay.

The initially closed valves 115A assigned to the receiving cavity 104 seal the fluid system 103 and/or the cartridge 100 in particular fluidically and/or in a gas-tight manner, preferably until the sample P is introduced and/or the receiving cavity 104 is closed.

As an alternative or in addition to the initially closed valves 115A, one or more valves 115B are preferably provided which are open/not closed initially/normally and/or in the delivery state of the cartridge 100 and/or in an inoperative/initial position/state and/or when the cartridge 100 is not inserted into the analyzer 200. These valves 115B are used in particular to control the flows of fluid during the test and/or are referred to as initially/normally open valves 115B.

Preferably, the normally open valves 115B can (only) be closed by actuation, mostly preferred by means of the analyzer 200.

The cartridge 100 is preferably designed as a microfluidic card and/or the fluid system 103 is preferably designed as a microfluidic system.

In the present invention, the term “microfluidic” is preferably understood to mean that the respective volumes of the individual cavities, some of the cavities or all of the cavities 104 to 111 and/or channels 114 are, separately or cumulatively, less than 5 ml or 2 ml, preferably less than 1 ml or 800 in particular less than 600 μl or 300 μl, mostly preferred less than 200 μl or 100 μl.

Preferably, a sample P having a maximum volume of 5 ml, 2 ml or 1 ml can be introduced into the cartridge 100 and/or the fluid system 103, in particular the receiving cavity 104.

For example, the sample P may be introduced into the receiving cavity 104 and/or cartridge 100 by means of a pipette, syringe or other instrument.

Preferably, (all) reagents and liquids required for the test, the detection process and/or for other purposes are provided in the cartridge 100, i.e. introduced before the test, mostly preferred in liquid form as liquids or liquid reagents F and/or in dry form as dry reagents S, as indicated in the schematic view according to FIG. 2.

Furthermore, also (all) other liquids F required for the test, the detection process and/or for other purposes, in particular in the form of a wash buffer, a solvent for dry reagents S and/or a substrate, e.g., in order to form detection molecules and/or a redox system, are preferably provided in the cartridge 100, i.e. introduced before use, in particular before delivery.

The cartridge 100 preferably contains all the reagents and liquids required for pre-treating the sample P and/or for carrying out the test or assay, in particular for carrying out one or more amplification reactions or PCRs. Therefore, it is preferably only necessary to receive the optionally pre-treated sample P.

The cartridge 100, the fluid system 103 and/or the channels 114 preferably comprise sensor portions 116 or other apparatuses for detecting liquid fronts and/or flows of fluid.

It is noted that in FIGS. 2 and 3 various components, such as the channels 114, the valves 115, in particular the initially closed valves 115A and the normally open valves 115B, and the sensor portions 116 are, for reasons of clarity, only labelled in some cases. However, the same symbols are used in FIGS. 2 and 3, respectively, for each of these components.

As shown in FIG. 3, the sensor apparatus 113 preferably comprises electrical contacts 113E for electrically connecting the cartridge 100 and/or sensor apparatus 113.

The contacts 113E are arranged in particular on the flat side and/or back and/or around a central region 113H.

The cartridge 100 and/or the main body 101 preferably comprises a reinforced or angled edge 121 and/or a reinforcing rib 122, particularly preferably on the back 100B, as shown schematically in FIG. 3.

The cartridge 100 or the main body 101 preferably comprises a grip portion 123 in order to optimally grip and/or hold the cartridge 100 by hand. The grip portion 123 is in particular arranged and/or formed or integrally molded on a longitudinal side.

The edge 121 and/or the reinforcing rib 122 are used in particular to provide reinforcement for the cartridge 100 or the main body 101 transversely to the surface extension or plate plane H or flat side or back 100B. This is particularly advantageous when mounting/clamping the cartridge 100 in the analyzer 200. The increased rigidity makes it possible to apply high forces when mounting/clamping the cartridge 100.

The cartridge 100 and/or the main body 101 preferably has, in the region of the reaction cavity/cavities 109, a region of reduced wall thickness, a weakened portion or a depression 101E in order to allow or ensure that the reaction cavity/cavities 109 and/or the fluids located therein is/are thermally coupled to the associated reaction temperature-control apparatus 204A in an effective or improved manner

The cartridge 100 or the main body 101 preferably comprises at least one positioning portion 126, in particular two positioning portions 126 in the example shown, for mounting and/or positioning the cartridge 100 in a defined manner, in particular in the analyzer 200 while a sample P is being tested, as shown in FIG. 3.

The positioning portion 126 is in particular integrally molded on or formed in one piece with the main body 101.

The positioning portion 126 preferably projects from a flat side, in this case the back 100B, or the main plane H of the cartridge 100 or main body 101.

The positioning portion 126 is in particular cylindrical or hollow cylindrical and/or conical, preferably on the inside and/or outside.

The outside of the positioning portion 126 preferably tapers towards the free end or is conical. This is conducive to simple production and/or centering of the cartridge 100 in the analyzer 200.

The inside of the positioning portion 126 is preferably conical or widens towards the free end. This is conducive to simple production and/or centering of the cartridge 100 in the analyzer 200.

The two positioning portions 126 are preferably arranged in a line that is parallel to a side of the cartridge 100, in particular in a central line that is transverse to a longitudinal side of the cartridge 100.

In particular, in the view according to FIG. 3, one positioning portion 126 is arranged in the region of the lower longitudinal side of the cartridge 100. The other positioning portion 126 is arranged in particular in the vicinity of the optional reinforcing rib 122.

The cartridge 100 or the main body 101 preferably comprises a fluidic and/or pneumatic connection 129. In the example shown, preferably a plurality of connections or two connections 129 are provided.

The connection 129 or each connection 129 is used in particular for fluidically or pneumatically supplying an associated manipulating apparatus or for actuating said manipulating apparatus.

In the example shown, the connection 129 on the left-hand side is assigned in particular to the pump apparatus 112 and is preferably used to pneumatically reset a peristaltic pump formed by the pump apparatus 112.

In the example shown, the connection 129 on the right-hand side is preferably assigned to the sensor apparatus 113 and is used in particular to pneumatically actuate a sensor cover (not shown) in order to make a sensor compartment above the sensor apparatus 113 or sensor array smaller, in particular during detection.

Each connection 129 is preferably formed by a corresponding opening in the main body 101, in particular its back 100B.

A card-side seal, formed in particular by a suitable layer or film or the like, is preferably assigned to each connection 129. However, other technical solutions are also possible.

The receiving cavity 104 can be closed after the sample P has been received. The cartridge 100 preferably comprises a closure element 130 for this purpose.

In particular, the receiving cavity 104 can be closed in a liquid-tight and particularly preferably also gas-tight manner by the closure element 130. In particular, a closed fluid circuit can thus be formed, with the receiving cavity 104 being included. In particular, once the assigned valves 115A at the inlet, outlet and/or an intermediate connection of the receiving cavity 104 have been opened, the receiving cavity 104 thus forms part of the fluid system 103 of the cartridge 100, wherein the fluid system is preferably closed or can be closed by the closure element 130.

Once the sample P has been introduced into the receiving cavity 104 and said cavity has been closed, in particular by means of the closure element 130, the cartridge 100 can be inserted into and/or received in the proposed analyzer 200 in order to test the sample P, as shown in FIG. 1.

The analyzer 200 preferably comprises a preferably movable mount or receptacle 201 for mounting and/or receiving the cartridge 100. Preferably, the receptacle 201 can be moved up and down in order to eject and receive the cartridge 100, respectively.

Preferably, the cartridge 100 and/or the fluid system 103 is fluidically, in particular hydraulically, separated or isolated from the analyzer 200. In particular, the cartridge 100 forms a preferably independent and in particular closed or sealed fluidic or hydraulic system 103 for the sample P and the reagents and other liquids. In this way, the analyzer 200 does not come into direct contact with the sample P and/or other fluids and/or reagents and can in particular be reused for another test without being disinfected and/or cleaned first.

It is however provided that the analyzer 200 is connected or coupled mechanically, electrically, thermally and/or fluidically and/or pneumatically to the cartridge 100.

In particular, the analyzer 200 is designed to have a mechanical effect, in particular for actuating the pump apparatus 112 and/or the valves 115, and/or to have a thermal effect, in particular for temperature-controlling the reaction cavity/cavities 109 and/or the intermediate temperature-control cavity 110 and/or the sensor apparatus 113.

In addition, the analyzer 200 can preferably be pneumatically connected to the cartridge 100, in particular in order to actuate individual apparatuses, and/or can be electrically connected to the cartridge 100, in particular in order to collect and/or transmit measured values, for example from the sensor apparatus 113 and/or sensor portions 116.

The analyzer 200 preferably comprises a pump drive 202, the pump drive 202 in particular being designed for mechanically actuating the pump apparatus 112.

The analyzer 200 preferably comprises a connection apparatus 203 for in particular electrically and/or thermally connecting the cartridge 100 and/or the sensor arrangement or sensor apparatus 113.

As shown in FIG. 1, the connection apparatus 203 preferably comprises a plurality of electrical contact elements 203A, the cartridge 100, in particular the sensor arrangement or sensor apparatus 113, preferably being electrically connected or connectable to the analyzer 200 by the contact elements 203A.

The analyzer 200 preferably comprises one or more temperature-control apparatuses 204 for temperature-controlling the cartridge 100 and/or having a thermal effect on the cartridge 100, in particular for heating and/or cooling, the temperature-control apparatus(es) 204 (each) preferably comprising or being formed by a heating resistor or a Peltier element.

Preferably, individual temperature-control apparatuses 204, some of these apparatuses or all of these apparatuses can be positioned against the cartridge 100, the main body 101, the cover 102, the sensor apparatus 113 and/or individual cavities and/or can be thermally coupled thereto and/or can be integrated therein and/or can be operated or controlled in particular electrically by the analyzer 200. In the example shown, three different temperature-control apparatuses 204A, 204B and/or 204C are provided.

The analyzer 200 preferably comprises one or more actuators 205 for actuating the valves 115. Preferably, different (types or groups of) actuators 205A and 205B are provided which are assigned to the different (types or groups of) valves 115A and 115B for actuating each of said valves, respectively. Mostly preferred, the analyzer 200 comprises one or more actuators 205A for actuating the initially closed valves 115A and one or more actuators 205B for the normally open valves 115B.

The analyzer 200 preferably comprises one or more sensors 206. In particular, fluid sensors 206A are assigned to the sensor portions 116 and/or are designed or intended to detect liquid fronts and/or flows of fluid in the fluid system 103.

Mostly preferred, the fluid sensors 206A are designed to measure or detect, in particular in a contact-free manner, for example optically and/or capacitively, a liquid front, flow of fluid and/or the presence, the speed, the mass flow rate/volume flow rate, the temperature and/or another value of a fluid in a channel and/or a cavity, in particular in a respectively assigned sensor portion 116, which is in particular formed by a planar and/or widened channel portion of the fluid system 103.

Alternatively or additionally, the analyzer 200 preferably comprises one or more (other or additional) sensors 206B for detecting the ambient temperature, internal temperature, atmospheric humidity, position and/or alignment, for example by means of a GPS sensor, and/or the orientation and/or inclination of the analyzer 200 and/or the cartridge 100.

The analyzer 200 preferably comprises a control apparatus 207, in particular comprising an internal clock or time base for controlling the sequence of a test or assay and/or for collecting, evaluating and/or outputting or providing measured values in particular from the sensor apparatus 113, and/or from test results and/or other data or values.

The control apparatus 207 preferably controls or feedback controls the pump drive 202, the temperature-control apparatuses 204 and/or actuators 205, in particular taking into account or depending on the desired test and/or measured values from the sensor apparatus 113 and/or sensors 206.

Optionally, the analyzer 200 comprises an input apparatus 208, such as a keyboard, a touch screen or the like, and/or a display apparatus 209, such as a screen.

The analyzer 200 preferably comprises at least one interface 210, for example for controlling, for communicating and/or for outputting measured data or test results and/or for linking to other devices, such as a printer, an external power supply or the like. The interface 210 might be embodied as a wired or wireless interface 210.

The analyzer 200 preferably comprises a power supply 211 for providing electrical power, preferably a battery or an accumulator, which is in particular integrated and/or externally connected or connectable.

Preferably, an integrated accumulator is provided as a power supply 211 and is (re)charged by an external charging device (not shown) via a connection 211A and/or is interchangeable.

The analyzer 200 is preferably portable or mobile. Preferably, the analyzer 200 weighs less than 25 kg or 20 kg, mostly preferred less than 15 kg or 10 kg, in particular less than 9 kg or 6 kg.

The analyzer 200 preferably comprises a housing 212, preferably wherein all the components and/or some or all of the apparatuses of the analyzer 200 are integrated in the housing 212 and/or arranged in the interior space 212A thereof.

Mostly preferred, the cartridge 100 can be inserted or slid into the housing 212, and/or can be received by the analyzer 200, through an opening 213 which can in particular be closed, such as a slot or the like.

As already explained, the analyzer 200 can preferably be fluidically and/or pneumatically linked or connected to the cartridge 100, in particular to the sensor apparatus 113 and/or to the pump apparatus 112, preferably by means of one or more—fluidic or pneumatic—connections 129.

Mostly preferred, the analyzer 200 is designed to supply the cartridge 100, in particular the sensor apparatus 113 and/or the pump apparatus 112, with a working medium, preferably gas, in particular air.

Preferably, the working medium can be compressed and/or pressurized in the analyzer 200 or by means of the analyzer 200.

The analyzer 200 preferably comprises a pressurized gas supply 214 in order to provide a pressurized working medium, preferably gas, in particular air.

The pressurized gas supply 214 is preferably integrated in the analyzer 200 or the housing 212 and/or can be controlled or feedback controlled by means of the control apparatus 207.

Preferably, the pressurized gas supply 214 is electrically operated or can be operated by electrical power. In particular, the pressurized gas supply 214 can be supplied with electrical power by means of the power supply 211.

The analyzer 200 and/or pressurized gas supply 214 preferably comprises a connection element 214A, in particular in order to pneumatically connect the analyzer 200 and/or pressurized gas supply 214 to the cartridge 100, in particular the sensor apparatus 113 and/or pump apparatus 112, mostly preferred via the connection 129 or connections 129.

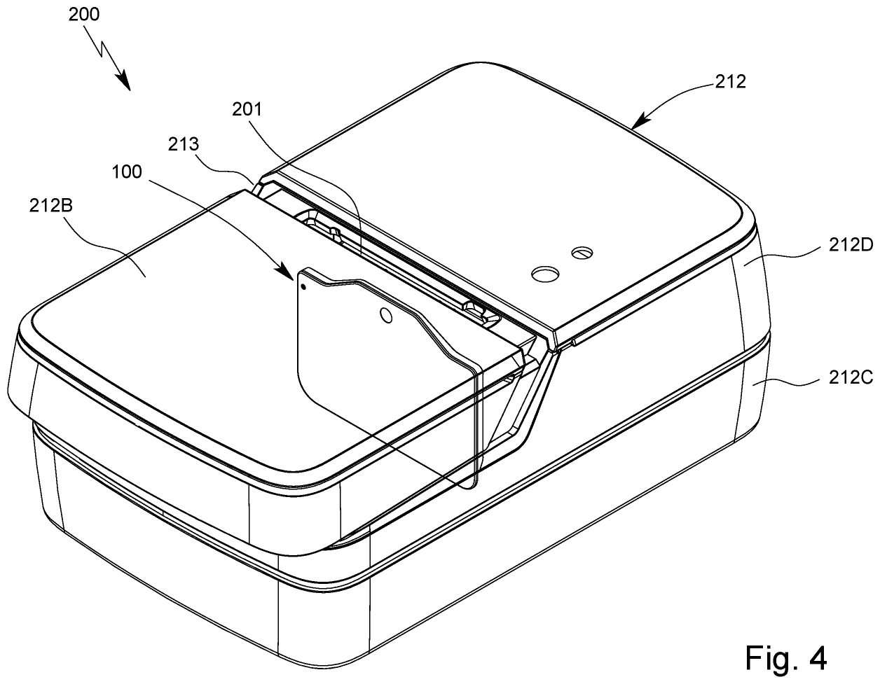

FIG. 4 shows the analyzer 200 in the open state/position, i.e. when the receptacle 201 is accessible and/or the opening 213 is formed. Here, the cartridge 100 has already been inserted into the analyzer 200, preferably through the opening 213 into the receptacle 201.

The analyzer 200 or housing 212 preferably comprises an access cover/housing part 212B that can be opened. Preferably, the analyzer 200, in particular its housing 212, can be opened by moving the access cover/housing part 212B relative to the housing 212, in particular a base 212C thereof, and/or such that the opening 213 is formed and/or the receptacle 201 is accessible, mostly preferred from the top.

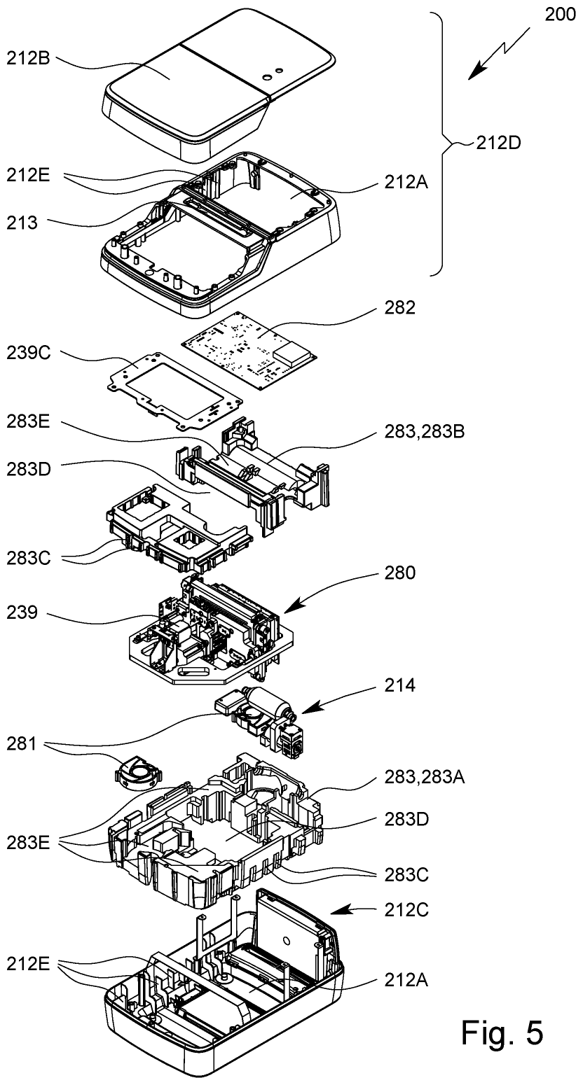

FIG. 5 is an exploded view of the analyzer 200, showing its preferred assembly.

As already mentioned, the analyzer 200 preferably comprises a housing 212 that contains/encompasses the main, in particular all, (mechanical and/or electrical) parts/components of the analyzer 200.

The analyzer 200 preferably comprises a preferably mechanical closing/clamping system 280, a pressurized gas supply 214, at least one ventilation apparatus 281, at least one electronic unit 282 and/or a support/cushion 283.

The clamping system 280 is preferably adapted to receive, hold, mount, position/align and/or clamp the cartridge 100 within the analyzer 200, in particular the housing 212, mostly preferred in order to conduct the test with the cartridge 100 in a predefined test position.

Preferably, the clamping system 280 is embodied as an assembly group and/or a unit and/or can be mounted/installed in and/or removed/disassembled from the analyzer 200, in particular its housing 212, as a whole and/or a unit and/or without disassembling the clamping system 280.

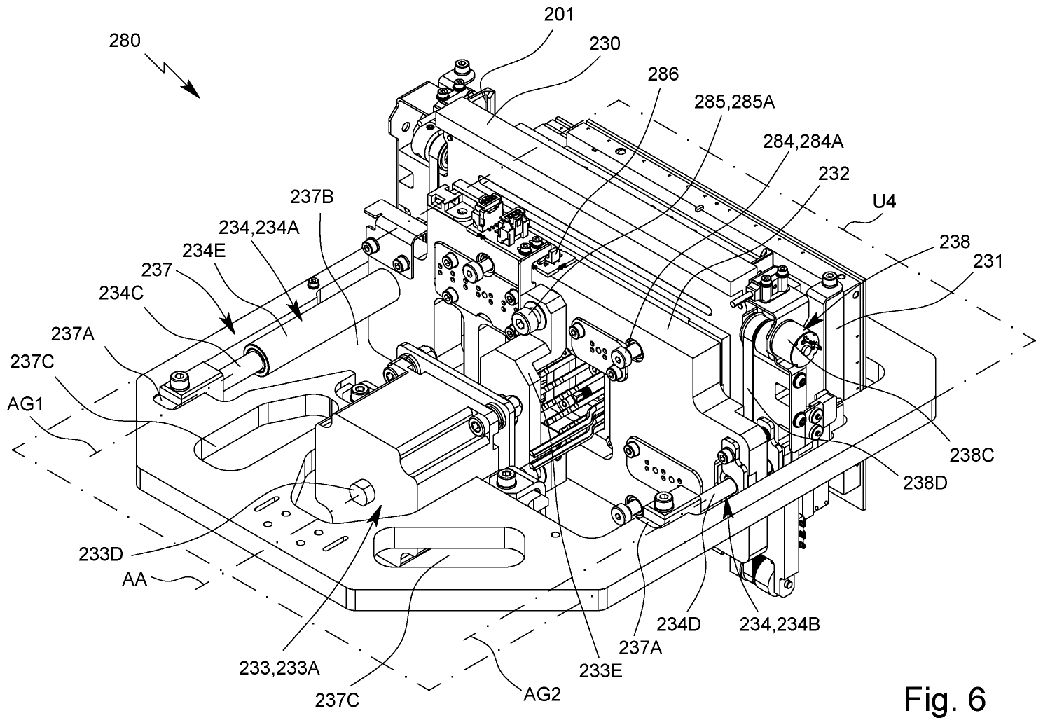

The clamping system 280 will be described later in detail with reference to FIGS. 6 to 18.

The ventilation apparatus 281 is preferably adapted to ventilate/cool the analyzer 200 or housing 212, in particular its interior 212A. In the embodiment shown in FIG. 5, the analyzer 200 preferably comprises several, here two, ventilation apparatuses 281.

As already mentioned, the pressurized gas supply 214 is preferably adapted to provide pressurized gas, preferably to the cartridge 100, in particular its sensor apparatus 113 and/or pump apparatus 112.

In the present embodiment, the pressurized gas supply 214, the clamping system 280, the ventilation apparatus 281 and the electronic unit 282 are preferably not rigidly connected to one another and, thus, do not form an assembly group/unit. However, it is also possible that some or all of these parts/components are rigidly connected to one another and/or form a (common) assembly group/unit. In particular, the pressurized gas supply 214, the ventilation apparatus 281 and/or the electronic unit 282 might be integrated into the clamping system 280.

The housing 212 is preferably a multi-piece construction and/or comprises a base 212C and a top 212D.

Preferably, the base 212C comprises or forms a bottom of the analyzer 200, in particular the housing 212. Mostly preferred, the base 212C is adapted to support and/or to bear the analyzer 200, in particular its inner parts, from below, at least when the analyzer 200 is in its position for use.

The top 212D of the housing 212 is preferably adapted to close/cover the analyzer 200, in particular its interior 212A, mostly preferred such that the analyzer 200, in particular the housing 212, is closed/protected/shielded to all directions.

Preferably, the top 212D comprises or forms the opening 213, that is accessible by moving the access cover/housing part 212B relative to the housing 212, in particular its top 212D.

The housing 212, in particular its base 212C and top 212D, forms and/or limits the interior 212A, in particular laterally.

Preferably, the housing 212 and/or its interior 212A is at least essentially cuboid. However, other constructional solutions are possible as well, e.g., wherein the housing 212 and/or its interior 212A is at least essentially cylindrical.

The support/cushion 283, hereinafter referred to as cushion 283, is preferably arranged within the housing 212.

The cushion 283 is preferably adapted to hold, support, bear, align and/or position some or all parts of the analyzer 200, in particular the pressurized gas supply 214, the clamping system 280, the ventilation apparatus 281 and/or the electronic unit 282, within the housing 212, in particular its interior 212A, mostly preferred such that these parts are immovable relative to one another, the cushion 283 and/or the housing 212.

In particular, the cushion 283 is adapted to secure these parts against unwanted/accidental displacement.

The cushion 283 is preferably of multi-piece construction and/or comprises a base 283A and a top 283B. However, it is also possible that the cushion 283 is formed integrally.

In the present embodiment, preferably also the top 283B of the cushion 283 is embodied as a multi-piece construction and/or comprises several, here two, parts. However, it is also possible, that the top 283B is formed integrally.

The base 283A of the cushion 283 is preferably adapted to support/hold/position/bear some or all parts of the analyzer 200, in particular the pressurized gas supply 214, the clamping system 280, the ventilation apparatus 281 and/or the electronic unit 282, mostly preferred from below and/or within the base 212C of the housing 212.

The top 283B of the cushion 283 is preferably adapted to cover some or all parts of the analyzer 200, in particular the pressurized gas supply 214, the clamping system 280, the ventilation apparatus 281 and/or the electronic unit 282. In the present embodiment, the top 283B of the cushion 283 holds/bears the electronic unit 282 form below. However, the electronic unit 282 could also be held by means of the base 283A.

Preferably, the cushion 283 is connected to the housing 212 in a force-fit and/or form-fit manner and/or by welding.

Preferably, the outer shape/contour of the cushion 283 corresponds at least essentially to the inner shape/contour of the housing 212, in particular the interior 212A, in particular such that the cushion 283 sits firmly, immovably and/or in a form-fit manner within the housing 212.

Preferably, the base 283A of the cushion 283, in particular its outer shape/contour, corresponds to the base 212C of the housing 212, in particular its inner shape/contour.

Preferably, the top 283B of the cushion 283, in particular its outer shape/contour, corresponds to the top 212D of the housing 212, in particular its inner shape/contour.

Preferably, the cushion 283 and the housing 212 interlock. In particular, the base 283A of the cushion 283 and the base 212C of the housing 212 on the one hand and the top 283B of the cushion 283 and the top 212D of the housing 212 on the other hand interlock.

Mostly preferred, the cushion 283, in particular its base 283A and/or top 283B, and the housing 212, in particular its base 212C and/or top 212D, comprise protrusions and recesses that correspond to each other, in particular such that an interlocking connection is or can be established.

The housing 212, in particular its base 212C and/or top 212D, preferably comprises at least one protrusion 212E, preferably wherein the protrusion 212E extends inwards and/or into the interior 212A and/or is embodied as a rip or the like.

The cushion 283, in particular its base 283A and/or top 283B, comprises preferably at least one recess 283C, preferably wherein the recess 283C is arranged on the outer surface of the cushion 283, in particular of its base 283A and/or top 283B, and/or matches/corresponds to the protrusion(s) 212E.

In the present embodiment, the housing 212, in particular its base 212C and/or top 212D, comprises a plurality of protrusions 212E, preferably wherein the protrusions 212E are preferably at least essentially equally distributed along the inner surface of the housing 212, in particular of its base 212C and/or top 212D.

The cushion 283, in particular its base 283A and/or top 283B, preferably comprises a plurality of recesses 283C, preferably wherein the recesses 283C are at least essentially equally distributed along the outer surface of the cushion 283, in particular of its base 283A and/or top 283B.

Alternatively or additionally, the housing 212, in particular its base 212C and/or top 212D, comprises recesses and the cushion 283, in particular its base 283A and/or top 283B, comprises protrusions, preferably wherein the recesses match/correspond to the protrusions.

The cushion 283 preferably comprises or forms an interior 283D that corresponds to and/or matches the parts that are supported by the cushion 283, in particular the pressurized gas supply 214, the clamping system 280, the ventilation apparatus 281 and/or the electronic unit 282.

Preferably, the inner shape/contour of the cushion 283, in particular of its base 283A and/or top 283B, corresponds to and/or matches the outer shape/contour of the supported parts, in particular the pressurized gas supply 214, the clamping system 280, the ventilation apparatus 281 and/or the electronic unit 282.

With other words, the cushion 283, in particular its base 283A and/or top 283B, reduces the inner shape/contour of the interior 212A of the housing 212, in particular its base 212C and/or top 212D, to the interior 283D of the cushion 283, in particular such that some or all parts of the analyzer 200, in particular the pressurized gas supply 214, the clamping system 280, the ventilation apparatus 281 and/or the electronic unit 282, are rigidly/immovably/firmly held/positioned/supported/beared within the housing 212, in particular within the interior 283D.

The cushion 283, in particular its base 283A, preferably comprises at least one supporting/bearing surface/portion 283E for supporting/holding some or all parts of the analyzer 200, in particular the pressurized gas supply 214, clamping system 280, ventilation apparatus 281 and/or electronic unit 282, preferably from below and/or laterally.

The supporting portion 283E is preferably formed/shaped according to the shape/contour of the part/component contained therein.

In the present embodiment, the cushion 283, in particular its base 283A, preferably comprises several supporting portions 283E, preferably wherein each supporting portion 283E is individually formed/shaped according to the shape/contour of the part/component contained therein or bearing thereon.

Mostly preferred, the cushion 283 comprises one supporting portion 283E for the pressurized gas supply 214, one supporting portion 283E for the clamping system 280, in particular its rack 237, one supporting portion 283E for the ventilation apparatus 281 and one supporting portion 283E for the electronic unit 282.

In the embodiment shown, the supporting portion 283E for the electronic unit 282 is located or formed at the top 283B of the cushion 283. However, other solutions are also possible as well.

Preferably, the cushion 283 is flexible/elastic/deformable.

Mostly preferred, the cushion 283 is made of foam, in particular a foamed/expanded material, e.g., expanded polypropylene, expanded polyethylene, expanded polystyrene or the like.

As already mentioned, the cushion 283 preferably serves as a damper and/or absorbs vibration/shocks. In this way, the analyzer 200 is protected against external impacts that might influence the test and/or its results.

In the following, the clamping system 280 will be described in detail with reference to FIGS. 6 to 18.

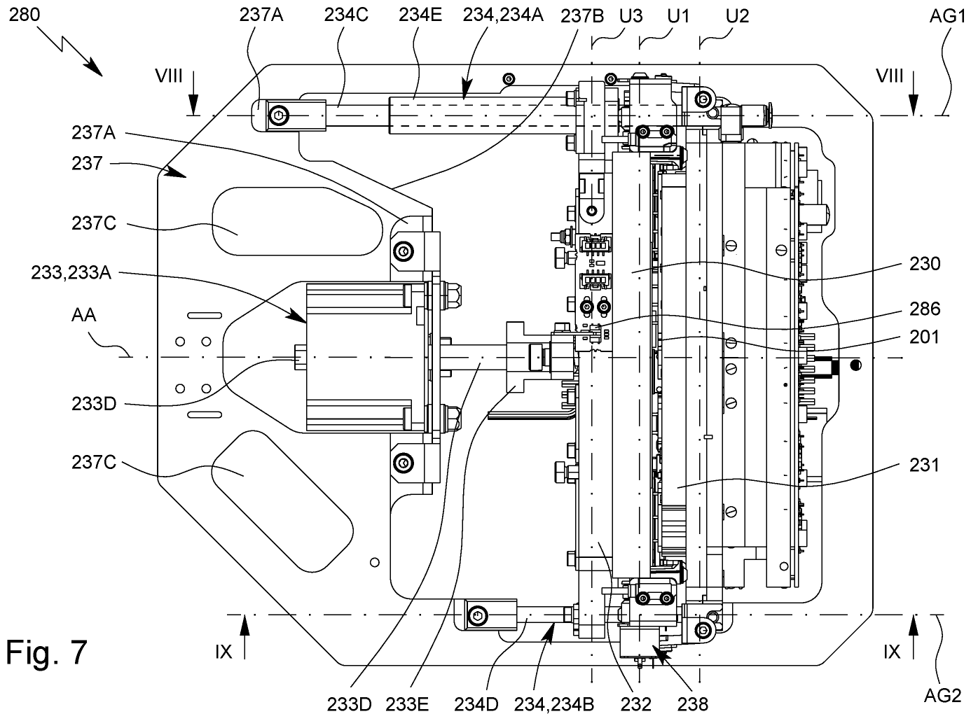

FIG. 6 shows a schematic perspective view of the clamping system 280, whereas FIG. 7 shows a schematic top view of the clamping system 280.

The analyzer 200, in particular the clamping system 280, is preferably designed to receive, position/align, hold and/or clamp the cartridge 100, in particular such that the cartridge 100 is positioned/aligned and/or firmly held within the analyzer 200, in particular the clamping system 280, mostly preferred in a pre-defined and/or repeatable manner, and/or can be mechanically, electrically, thermally, fluidically and/or pneumatically connected, mostly preferred to the pump drive 202, the connection apparatus 203, the temperature-control apparatus 204, the reaction temperature-control apparatus 204A, the intermediate temperature-control apparatus 204B, the sensor temperature-control apparatus 204C, the actuator(s) 205, the sensor(s) 206, the control apparatus 207, the input apparatus 208, the display apparatus 209, the interface 210, the power supply 211 and/or the pressurized gas supply 214.

The analyzer 200, in particular the clamping system 280, preferably comprises an optional receiving/intermediate unit 230, a connection unit 231, a clamping/actuator unit 232, a drive apparatus 233, a guide apparatus 234, a rack/frame 237, a lifting apparatus 238 and/or an opening apparatus 239.

For the sake of clarity, the opening apparatus 239 is not shown in FIGS. 6 and 7, which will be primarily used in the following for the description of the clamping system 280, in particular the guide apparatus 234.

The clamping system 280, in particular the clamping unit 232, the intermediate unit 230, the connection unit 231 and/or the lifting apparatus 238, preferably comprise(s) or form(s) the slot/receptacle 201 for mounting and/or receiving the cartridge 100.

Mostly preferred, the receptacle 201 is formed/arranged between the clamping unit 232 and/or the intermediate unit 230 on the one hand and the connection unit 231 on the other hand.

In particular, the receptacle 201 is laterally limited by the intermediate unit 230, connection unit 231 and/or clamping unit 232 and/or at the bottom by means of the lifting apparatus 238.

Preferably, the optional intermediate unit 230 and/or the lifting apparatus 238 are arranged between the clamping unit 232 and the connection unit 231.

The intermediate unit 230, the connection unit 231, the clamping unit 232 and/or the lifting apparatus 238 are preferably movable/slidable relative to one another and/or back and forth, in particular in order to hold the cartridge 100 in a clamped manner for the test and/or in a test position and/or to release/eject the cartridge 100 after the test has been completed.

Due to the movement of the intermediate unit 230, connection unit 231 and/or clamping unit 232 relative to one another, the distance between the intermediate unit 230, connection unit 231 and/or clamping unit 232 and, thus, the volume of the receptacle 201 can be reduced and increased.

The intermediate unit 230 or its main body 230B, connection unit 231 or its main body 231D and/or clamping unit 232 or its main body 232D are preferably at least essentially flat and/or plate-like and/or constructed/assembled from a plurality of plates or plate-shaped components.

The intermediate unit 230, connection unit 231 and/or clamping unit 232 and/or the respective main planes U1 to U3 thereof are preferably arranged at least essentially parallel to one another and/or side by side.

Preferably, the intermediate unit 230 comprises/defines a main extension plane U1, the connection unit 231 comprises/defines a main extension plane U2 and/or the clamping unit 232 comprises/defines a main extension plane U3, preferably wherein the planes U1, U2 and/or U3 are arranged at least essentially parallel to one another and/or to the (inserted) cartridge 100 and/or its main extension plane H, at least when being in the actuated/end/test/clamping position, as shown in FIG. 7.

The drive apparatus 233 is preferably adapted to move/actuate the clamping unit 232, intermediate unit 230, connection unit 231 and/or the lifting apparatus 238, in particular relative to one another, back and forth and/or in the direction of actuation.

Mostly preferred, the drive apparatus 233 is adapted to push the clamping unit 232, intermediate unit 230, connection unit 231 and/or the lifting apparatus 238 in order to clamp/position/align the cartridge 100, in particular between the clamping unit 232 and the connection unit 231, and/or to pull the clamping unit 232, intermediate unit 230, connection unit 231 and/or the lifting apparatus 238 in order to release the cartridge 100 for ejection and/or when the test has been completed.

Thus, the drive apparatus 233 preferably operates into two (opposing) directions of actuation, in particular a first actuation direction towards the connection unit 231 and a second actuation direction away from the connection unit 231.

The drive apparatus 233 preferably comprises an in particular electrical drive/motor 233A, a shaft 233D and/or a preferably fork-shaped drive head 233E.

Preferably, the drive apparatus 233, in particular its drive 233A, is embodied as a stepper motor and/or comprises a threaded spindle as shaft 233D. However, other constructional solutions are possible as well.

In the present embodiment, the connection unit 231 is preferably fixed, immovable and/or stationary, in particular relative to the drive apparatus 233 and/or rack 237, and/or only the clamping unit 232, the intermediate unit 230 and/or the lifting apparatus 238 are movable/slidable and/or driven by means of the drive apparatus 233. However, other constructional solutions are possible as well, wherein the connection unit 231 is movable/slidable, in particular additionally or alternatively to the intermediate unit 230, the clamping unit 232 and/or the lifting apparatus 238. The connection unit 231 might be driven by the drive apparatus 233 or an additional drive apparatus.

The following description mainly refers to the present embodiment, i.e. with regard to the movement of the clamping unit 232, the intermediate unit 230 and/or the lifting apparatus 238, but may also apply to other embodiments correspondingly, in particular in which the connection unit 231 is movable/slidable additionally or alternatively to the clamping unit 232, the intermediate unit 230 and/or the lifting apparatus 238.

The drive apparatus 233 is preferably adapted to move/actuate the clamping unit 232, the intermediate unit 230 and/or the lifting apparatus 238 back and forth and/or in the direction of and away from the (preferably fixed) connection unit 231.

The drive apparatus 233, in particular its shaft 233D, preferably comprises/defines an actuation axis AA, preferably wherein the shaft 233D and/or the actuation axis AA are/is arranged at least essentially perpendicular to the intermediate unit 230 or its main plane U1, the connection unit 231 or its main plane U2 and/or the clamping unit 232 or its main plane U3 and/or runs at least essentially centrally through the intermediate unit 230, connection unit 231 and/or clamping unit 232 and/or through the center of gravity of the analyzer 200, in particular of the clamping system 280, of the intermediate unit 230, of the connection unit 231 and/or of the clamping unit 232.

The direction(s) of actuations correspond(s) preferably to the actuation axis AA of the drive apparatus 33.

The drive apparatus 233, in particular its drive head 233E, is preferably attached to (the center of) the clamping unit 232 and/or (the center of) the intermediate unit 230.

Preferably, the clamping unit 232 and/or the intermediate unit 230 are/is arranged between the connection unit 231 and the drive apparatus 233, in particular the drive head 233E. Mostly preferred, the intermediate unit 230 is arranged between the connection unit 231 and clamping unit 232.

As already mentioned, the analyzer 200, in particular the clamping system 280, preferably comprises a mounting frame/rack 237, hereinafter referred to as rack 237, preferably wherein some or all parts of the clamping system 280, in particular the intermediate unit 230, the connection unit 231, the clamping unit 232, the drive apparatus 233, the guide apparatus 234, the lifting apparatus 238 and/or the opening apparatus 239 are (directly) mounted on and/or (rigidly/immovably) attached to the rack 237.

In the present embodiment, the connection unit 231, the drive apparats 233, the guide apparatus 234, the lifting apparatus 238 and the opening apparatus 239 are directly mounted on and/or rigidly/immovably attached to the rack 237, whereas the clamping unit 232 and the intermediate unit 230 are movably attached to the rack 237, in particular via the guide apparatus 234, as will be explained later.

The rack 237 preferably comprises at least one mounting surface 237A for mounting some or all parts of the clamping system 280, in particular the connection unit 231, the drive apparatus 233 and/or the guide apparatus 234. Mostly preferred, the rack 237 comprises at least one mounting surface 237A for the connection unit 231, at least one mounting surface 237A for the drive apparatus 233 and/or at least one mounting surface 237A for the guide apparatus 234.

Preferably, the connection unit 231, the guide apparatus 234, the lifting apparatus 238 and the opening apparatus 239 are connected to the rack 237, in particular its mounting surfaces 237A, in a force-fitting manner and/or by screwing.

The rack 237 preferably mechanically connects and/or holds/supports some or all parts of the clamping system 280, in particular the intermediate unit 230, the connection unit 231, the clamping unit 232, the drive apparatus 233, the guide apparatus 234, the lifting apparatus 238 and/or the opening apparatus 239.

Mostly preferred, the rack 237 is at least essentially flat and/or plate-like and/or comprises or defines a main extension plane U4.

The rack 237 preferably extends around and/or encompasses some or all parts of the clamping system 280, in particular the intermediate unit 230, connection unit 231, the clamping system 232, the drive apparatus 233, the guide apparatus 234, the lifting apparatus 238 and/or the opening apparatus 239.

Preferably, the rack 237, in particular its main plane U4, is arranged at least essentially perpendicular to the main plane U1 of the intermediate unit 230, the main plane U2 of the connection unit 231, main plane U3 of the clamping unit 232 and/or the (inserted) cartridge 100 or its main plane H.

The rack 237, in particular its main plane U4, is preferably aligned at least essentially horizontally in the operating position of the analyzer 200 and/or parallel to the bottom of the analyzer 200 and/or arranged in the center of the analyzer 200, in particular the housing 212 and/or the clamping system 280.

Mostly preferred, the center of gravity of the analyzer 200, in particular its clamping system 280, and/or the central/actuation axis AA of the drive apparatus 233 is located within the main plane U4 of the rack 237.

The rack 237 preferably comprises/forms/encompasses a mounting area 237B, preferably wherein all or some parts of the clamping system 280, in particular the intermediate unit 230, the connection unit 231, the clamping unit 232, the drive apparatus 233, the guide apparatus 234, and/or the lifting apparatus 238, are mounted/arranged within the mounting area 237B.

The mounting area 237B is preferably formed as a cutout of the rack 237 or a plurality of cutouts for the various components of the clamping system 280.

The rack 237 might be equipped with at least one (further) cutout 237C in which no component of the clamping system 280 is mounted/arranged in order to reduce its weight.

The rack 237 is preferably rigid and/or made of metal, mostly preferred of aluminum.

Preferably, the rack 237 is harder/stiffer than the cushion 283.

As already mentioned, the analyzer 200, in particular the clamping system 280, preferably comprises a guide apparatus 234 for (movably/slidably) guiding/bearing the intermediate unit 230, connection unit 231 and/or clamping unit 232.

In the present embodiment, both, the clamping unit 232 and the optional intermediate unit 230, are driven/moved by means of the drive apparatus 233 and guided by means of the guide apparatus 234. However, it is also possible that only one of the units 230, 232, in particular the clamping unit 232, is driven/moved by means of the drive apparatus 233 and guided by means of the guide apparatus 234.

The connection unit 230 might additionally or alternatively be guided by means of the guide apparatus 234.

In the following, the movement/guidance primarily of the clamping unit 232 will be described. However, the intermediate unit 230 and—additionally or alternatively—the connection unit 231 can be driven/moved/guided in the same or a similar manner

The guide apparatus 234 preferably holds/bears/guides the clamping unit 232, in particular in a movable/slidable manner and/or such that it can move/slide towards and away from the connection unit 231, mostly preferred within the rack 237 or its mounting area 237B and/or in the direction of actuation.

The guide apparatus 234 preferably comprises/forms a (linear) guide track, on which the clamping unit 232 and/or the intermediate unit 230 are/is guided.

The guide apparatus 234 is preferably embodied as a linear-motion bearing and/or allows a linear movement of the intermediate unit 230 and/or the clamping unit 232 on a predefined track and/or in the direction of actuation.

The intermediate unit 230 and/or the clamping unit 232 are/is preferably held/guided/beared on both/opposing sides and/or at the edges by means of the guide apparatus 234.

The guide apparatus 234 preferably comprises a plurality of guides, here two guides 234A, 234B, for movably/slidably guiding the intermediate unit 230 and/or clamping unit 232.

Preferably, the guide apparatus 234 comprises a first/main guide 234A, hereinafter referred to as first guide 234A, and a second/compensation guide 234B, hereinafter referred to as second guide 234B.

The guide apparatus 234 preferably comprises a plurality of rails/rods 234C, 234D and/or a plurality of bushes/slides/bearings 234E, 234F.

The guide apparatus 234 preferably comprises and/or is formed by a first/main rail 234C, a second/compensation rail 234D, a first/main bush 234E and a second/compensation bush 234F (not visible in FIGS. 6 and 7).

Mostly preferred, the first guide 234A comprises and/or is formed by the first rail 234C and the main bush 234E and/or the second guide 234B comprises and/or is formed by the second rails 234D and/or the compensation bush 234F.

Preferably, the bushes 234E, 234F are movably/slidably attached to the corresponding rails 234C, 234D. In particular, the main bush 234E is movably/slidably attached to the first rail 234C and the compensation bush 234F is movably/slidably attached to the second rail 234D.

The guide apparatus 234 might be equipped with further bushes that might also be embodied as main bushes 234E and/or compensation bushes 234F, as will be explained later.

The guides 234A, 234B, in particular the rails 234C, 234D, are preferably elongated and/or at least partially extend over the length of the analyzer 200, in particular its clamping system 280.

Preferably, the guides 234A, 234B, in particular the rails 234C, 234D, are bar/rod-shaped, have a round/circular section and/or are cylindrical. However, it is also possible that the rails 234C, 234D are embodied as profiled rails having a non-circular profile.

The guides 234A, 234B, in particular the rails 234C, 234D, are preferably arranged and/or integrated in the longitudinal sides of the rack 237. According to another preferred embodiment (not shown), the guides 234A, 234B, in particular the rails 234C, 234D, preferably form the longitudinal sides of the rack 237.

Preferably, the guides 234A, 234B, in particular the rails 234C, 234D, are arranged at least essentially parallel to one another, parallel to the longitudinal sides of the clamping system 280, in particular the rack 237, parallel to the shaft 233D of the drive apparatus 233 and/or on opposing sides of the rack 237.

The first guide 234A and/or first rail 234C preferably comprises/defines a first guide axis AG1, and/or the second guide 234B and/or the second rail 234D preferably comprises/forms a second guide axis AG2.

Preferably, the guide apparatus 234, in particular the guides 234A, 234B, rails 234C, 234D and/or the guide axes AG1, AG2, is/are arranged parallel to the main plane U4 of the rack 237 and/or actuation axis AA of the drive apparatus 233 and/or at least essentially perpendicular to the main plane U1 of the intermediate unit 230, the main plane U2 of the connection unit 231, the main plane U3 of the clamping unit 232 and/or the main plane H of the (inserted) cartridge 100.

The guide apparatus 234, in particular the guides 234A, 234B and/or rails 234C, 234D, is/are preferably mounted on and/or attached to the rack 237, in particular its mounting surface(s) 237A, and/or the connection unit 231.

The guides 234A, 234B, in particular the rails 234C, 234D, are preferably attached/mounted at one end on/to the rack 237, in particular its mounting surface(s) 237A, and/or attached/mounted at the other end on/to the connection unit 231.

As best seen in FIGS. 6 and 7, the guides 234A, 234B, in particular the rails 234C, 234D and/or the bushes 234E, 234F, preferably differ from one another.

Preferably, the first guide 234A, the first rail 234C and/or the main bush 234E are/is longer and/or thicker than the second guide 234B, the second rail 234D and/or the compensation bush 234F.

As already mentioned, the first guide 234A, in particular the main bush 234E, is preferably adapted to provide a precise guidance and/or a guidance that is at least essentially free of (radial/angular) play, whereas the second guide 234B, in particular the compensation bush 234F, is preferably adapted to compensate (radial/angular) misalignments between the moving parts and/or to allow tilting of the intermediate unit 234, connection unit 231 and/or clamping unit 232 relative to one another and/or relative to the rails 234C, 234D.

Preferably, the tiltability/play provided by the compensation bush 234F is larger than the tiltability/play provided by the main bush 234E.

Preferably, the main bush 234E is at least two, in particular at least three, mostly preferred at least four times, longer than the compensation bush 234F.

Preferably, the main bush 234E is longer than 1 cm or 2 cm, in particular longer than 5 cm or 10 cm, and/or shorter than 50 cm or 30 cm, in particular shorter than 15 cm.

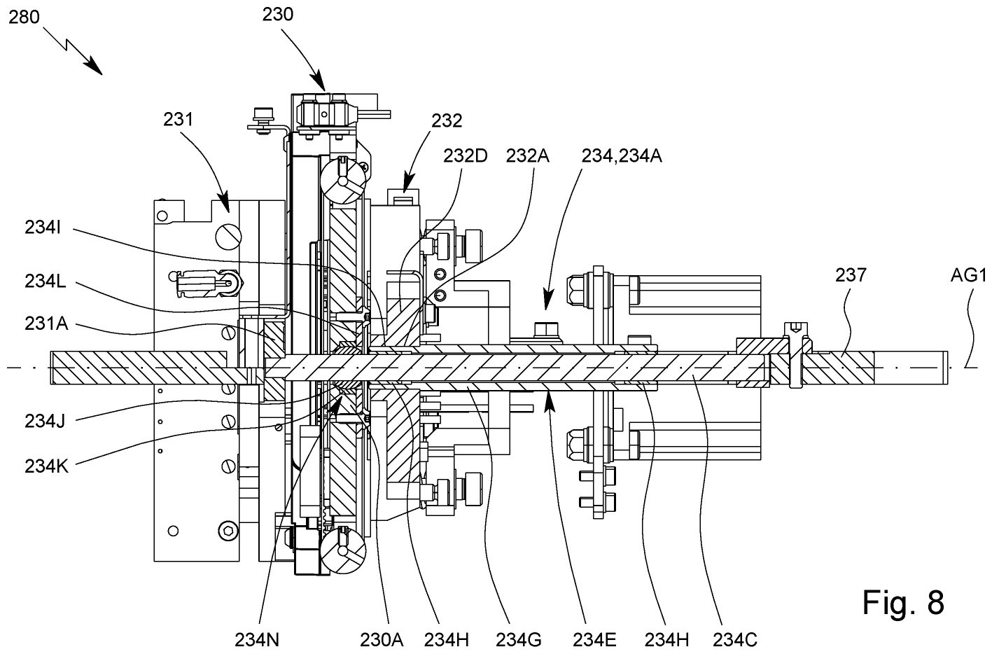

The first guide 234A will be described in the following with reference to FIG. 8, which shows a schematic section of the clamping system 280 along the line VIII-VIII shown in FIG. 7 (line VIII-VIII corresponds to the axis AG1 of the first guide 234A).

The main bush 234E preferably comprises an outer shell 234G and/or at least one gliding element 234H, preferably wherein the gliding element 234H is arranged within the shell 234G.

The main bush 234E, in particular its shell 234G, is preferably embodied as an elongated hollow cylinder.

Preferably, the main bush 234E, in particular its shell 234G, is made out of metal.

The main bush 234E, in particular its shell 234G, is preferably attached to the clamping unit 232, preferably rigidly/immovably and/or in an axial and radial fixed/immovable manner.

Preferably, the bush 234E, in particular its shell 234G, and the clamping unit 232 are connected to one another in a form-fitting and/or force-fitting, in particular press-fitting, manner and/or by welding.

Mostly preferred, the bush 234E, in particular its shell 234G, and the clamping unit 232 are connected to one another without radial, axial and/or angular play and/or in an axial and radial fixed/immovable manner

The clamping unit 232 preferably comprises at least one bearing portion 232A for the first guide 234A, in particular the main bush 234E.

Preferably, the bearing portion 232A is embodied as an opening, in particular a hole, in the clamping unit 232, in particular its main body 232D.

Preferably, (only) an axial end of the main bush 234E is inserted into the clamping unit 232, preferably its main body 232D, in particular the bearing portion 232A.

Preferably, the main bush 234E, in particular its shell 234G, mostly preferred an axial end thereof, comprises or forms a bearing surface 234I, preferably wherein the clamping unit 232 sits, in particular flush, on the bearing surface 234I and/or the bearing surface 234I is in direct contact with the inner wall of the bearing portion 232A.

The main bush 234E, in particular its shell 234G, mostly preferred the bearing surface 234I, is preferably inserted and/or press-fitted into the bearing portion 232A, in particular such that the main bush 234E and the clamping unit 232 are rigidly connected to one another and/or in an axial and/or radial immovable manner

Preferably, the main bush 234E extends out of the clamping unit 232, in particular in the direction of the drive apparatus 233 and/or away from the connection unit 231, in particular such that the main bush 234E does not interfere with the closing mechanism.

The optional gliding element 234H is preferably adapted to reduce the friction between the shell 234G and the first rail 234C.

The gliding element 234H is preferably arranged within the shell 234G and/or between the inner surface of the shell 234G and the rail 234C.

Preferably, the gliding element 234 H serves as a spacer between the shell 234G and the rail 234C.

Mostly preferred, the gliding element 234H is in direct contact with and/or directly sits, in particular flush, on the first rail 234C.

Preferably, the gliding element 234H is immovably attached to the shell 234G and/or connected to the shell 234G in a force-fitting and/or form-fitting manner and/or by welding.

The gliding element 234H is preferably embodied as a hollow cylinder and/or made of plastic.

Mostly preferred, the main bush 234E comprises a plurality of, here two, gliding element 234H, preferably wherein one gliding element 234H is arranged at each of the axial ends of the main bush 234E.

In particular, one gliding element 234H is arranged within the bearing portion 232A.

Of course, other constructional solutions are possible as well, in particular wherein the gliding element 234H extends through the entire shell 234G. It is also possible that the inner surface of the main bush 234E, in particular of its shell 234G, is coated in order to reduce the friction between the shell 234G and the rail 234C.

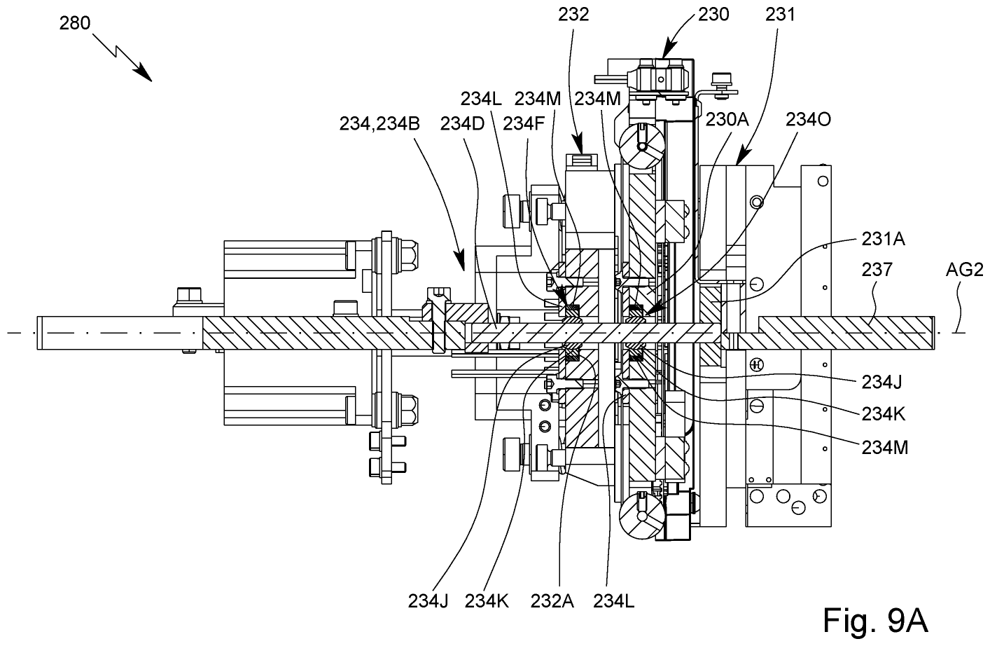

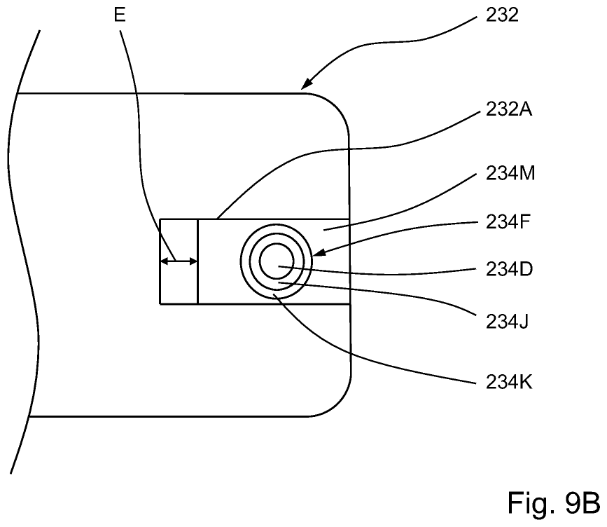

The second guide 234B will be described in the following preference to FIGS. 9A and 9B. FIG. 9A shows the section of the clamping system 280 along the line IX-IX shown in FIG. 7 (line IX-IX corresponds to the axis AG2 of the second guide 234B). FIG. 9B shows the section of the partially shown clamping unit 232 along its main plane U3.

As already mentioned, the second guide 234B, in particular the compensation bush 234F thereof, is preferably adapted to compensate radial, in particular horizontal, and/or angular misalignments within the clamping system 280, in particular between the intermediate unit 230, the connection unit 231, the clamping unit 232 and/or the guide apparatus 234, mostly preferred its rails 234C, 234D, and/or to prevent jamming of the moving parts and/or to allow tilting of the clamping unit 232, intermediate unit 230, connection unit 231 and/or guide apparatus 234, mostly preferred its rails 234C, 234D, relative to one another.

Thus, in contrast to the first guide 234A and/or its main bush 234E, the second guide 234B and/or its compensation bush 234F is preferably constructed in such a way that it allows a (guided) radial, in particular horizontal, movement and/or a (guided) tilting/angular movement of the clamping unit 232, the intermediate unit 230, the connection unit 231 and/or guide apparatus 234, in particular its rails 234C, 234D, relative to one another.

With other words, the play and/or the tiltability is different on the different sides of analyzer 200, in particular its guide apparatus 234.

Preferably, the radial play and/or the angular play, i.e. the tiltability, of the second guide 234B and/or compensation bush 234F is larger than the radial play and/or the angular play of the first guide 234A and/or the main bush 234E, preferably by a factor of at least two, three or five.

In order to allow a (guided) tilting of the clamping unit 232, the compensation bush 234F is preferably embodied as a spherical bearing and/or as a multi-piece construction.

Preferably, the compensation bush 234F comprises at least two parts/components that are movable, in particular tiltable and/or angular rotational, relative to one another.

The compensation bush 234F preferably comprises an inner part 234J and/or an outer part 234K, preferably wherein the parts 234J, 234K are embodied as rings.

Preferably, the outer diameter of the inner part 234J corresponds to the inner diameter of the outer part 234K.

The compensation bush 234F, in particular its outer part 234K, is preferably (directly or indirectly) attached to the clamping unit 232, in particular a second or associated bearing portion 232A, in particular in an axial fixed/immovable manner and/or such that no axial movement between the compensation bush 234F, in particular its outer part 234K and the clamping unit 232, in particular its second bearing portion 232A, is possible.

The (second) bearing portion 232A for the second guide 234B is preferably embodied similar to the (first) bearing portion 232A for the first guide 234A. However, the bearing portions may differ in diameter.

The guide apparatus 234, in particular the second guide 234B and/or the compensation bush 234F, preferably comprises a securing part 234L in order to secure the compensation bush 234F, in particular its outer part 234K, within the clamping unit 232, in particular the bearing portion 232A, and/or against loosening and/or such that it is axially fixed/secured.

In the present embodiment, the securing part 234L is preferably embodied as a preferably ring-shaped and/or curved plate that is axially attached to the clamping unit 232 and/or holds the outer part 234K within the associated bearing portion 232A.

Mostly preferred, the outer part 234K and/or the securing part 234L are/is connected to the clamping unit 232, in particular the associated bearing portion 232A, by form-fit, force-fit and/or by welding, in particular by screwing.

The inner part 234J and the outer part 234K are preferably movable, in particular rotatable and/or tiltable, relative to one another. Mostly preferred, the inner part 234J is movable held within/by the outer part 234K.

The outer surface of the inner part 234J and the inner surface of the outer part 234K are preferably spherical.

Preferably, the inner surface of the outer part 234K is concave and the outer surface of the inner part 234J is convex. In this way, the inner part 234J and/or the second rail 234D can tilt within and/or relative to the outer part 234K.

The inner surface of the inner part 234J is preferably in direct contact with the second rail 234D. In particular, the inner part 234J directly slides on the second rail 234D. However, it is also possible, that the compensation bush 234F comprises a gliding element, a coating or the like, in particular in order to reduce the friction between the compensation bush 234F and the second rail 234D, in particular between the inner part 234J and the outer part 234K.

Due to the guide apparatus 234, in particular the second guide 234B and/or the compensation bush 234F, the angle enclosed between the second guide axis AG2 and the main plane U3 of the clamping unit 232 can vary and/or be adapted by at least 0.1° or 0.5°, preferably by at least 1° or 5°, and/or by at most 20° or 10°. The variation of the angle is preferably limited due to the associated bearing portion 232A and/or the stops formed by the inner surface thereof.

Thus, the analyzer 200, preferably the clamping system 280, in particular the guide apparatus 234, preferably comprises/provides a preferably single-side angular play preferably for the clamping unit 232 and/or the second rail 234D and/or for an angular movement between the second rail 234D on the one hand and the clamping unit 232 and/or the first rail 234C on the other hand, in particular by means of the second guide 234B and/or its compensation bush 234F.

Additionally or alternatively, the analyzer 200, preferably the clamping system 280, in particular the guide apparatus 234 and/or the clamping unit 232, comprises/provides a (single-side) radial, in particular horizontal, play E, preferably for the clamping unit 232 and/or the second rail 234D and/or for a radial, in particular horizontal, movement between the second rail 234D on the one hand and the clamping unit 232 and/or the first rail 234C on the other hand, as indicated by arrows in FIG. 9B.

Preferably, the radial play E is a gap between the compensation bush 234F, in particular its outer part 234K, and the clamping unit 232, in particular the associated bearing portion 232A, preferably wherein the gap is longer than 0.1 mm or 0.5 mm, mostly preferred longer than 1 mm, and/or smaller than 5 mm or 2 mm.

Preferably, the associated bearing portion 232A, in particular its (inner) diameter or width, is larger than the outer diameter or width of the compensation bush 234F, in particular its outer part 234K, in order to provide the radial play E.

With other words, the compensation bush 234F is preferably (radially) float-mounted to the clamping unit 232 and/or its associated bearing portion 232A.

Due to the radial play E a radial, i.e. horizontal and/or vertical, movement of the second guide 234B, in particular the second rail 234D, relative to clamping unit 232 and/or relative to the first guide 234A, in particular the first rail 234C, and/or within the main plane U4 of the rack 237 and/or transverse/perpendicular to the actuation axis AA and/or first guiding axis AG1 is possible. In this way, radial misalignment/offset between the guides 234A, 234B and/or rails 234C, 234D, e.g., caused by thermal expansion, can be compensated.

In the present embodiment, the radial play E is a horizontal play and/or allows (only) a horizontal movement of the clamping unit 232 relative to the second guide 234B, in particular the second rail 234D, and/or a movement of the second guide 234B, in particular the second rail 234D, relative to and/or towards the first guide 234A, in particular the first rail 234C, and/or within the main plane U4 of the rack 237.

Thus, the clamping unit 232 is preferably vertically fixed relative to the guide apparatus 234.

The term “horizontal” is preferably understood to refer to a direction within and/or parallel to the main plane U4 of the rack 237 and/or defined by the guide axes AG1, AG2.

The term “vertical” is preferably understood to refer to a direction perpendicular to the main plane U4 of the rack 237 and/or defined by the guide axes AG1, AG2.

The compensation bush 234F is preferably directly or indirectly connected to the clamping unit 232, in particular the associated bearing portion 232A.

Preferably, the analyzer 200, in particular the guide apparatus 234, mostly preferred the compensation bush 234F, comprises a bearing part 234M, preferably wherein the bearing part 234M is adapted to connect the compensation bush 234F to the clamping unit 232, in particular its associated bearing portion 232A.

The bearing part 234M is preferably adapted to (radially) hold the compensation bush 234F and/or the outer part 234K thereof. In particular, the bearing part 234M comprises a receptacle for the compensation bush 234F and/or its outer part 234K.

Preferably, the bearing part 234M is cuboid and/or embodied as preferably cuboid-shaped insert.

The bearing part 234M is preferably made of plastic, in particular in order to decrease the friction between the clamping unit 232 and the outer part 234K.

However, other constructional solutions are possible, in particular wherein the outer part 234K is cuboid and/or embodied as a preferably cuboid-shaped insert. In particular, the bearing part 234M and the outer part 234K can be formed integrally.

The associated bearing portion 232A is preferably correspondingly cuboid and/or embodied as a preferably cuboid opening.

Preferably, the height and/or vertical extension of the associated bearing portion 232A corresponds to the height and/or vertical extension of the bearing part 234M, in particular such that no vertical play/gap is provided between the compensation bush 234F and the clamping unit 232 and/or such that the compensation bush 234F and/or the bearing part 234M cannot vertically move within the associated bearing portion 232A.

Mostly preferred, the compensation bush 234F is held by means of the clamping unit 232 in vertical direction without play/clearance.

Preferably, the compensation bush 234F, in particular the bearing part 234M, can horizontally move/slide within the clamping unit 232, in particular the associated bearing portion 232A.

Preferably, the length/width and/or horizontal extension of the associated bearing portion 232A or its opening is larger than the length/width and/or horizontal extension of the bearing part 234M, in particular such that the horizontal play E is provided between the compensation bush 234F and the clamping unit 232 and/or such that the compensation bush 234F and/or the bearing part 234M can horizontally move/slide within the associated bearing portion 232A, at least in a predefined range.

Mostly preferred, the compensation bush 234F is held by means of the clamping unit 232 in horizontal direction with the play E.

Preferably, the bearing part 234M is secured within the bearing portion 232A and/or against removal by means of the securing part 234L (in FIG. 9B not shown).

As already mentioned, the intermediate unit 230 is preferably (also) guided, in particular by means of the (same) guide apparatus 234, and/or (also) movable relative to the connection unit 231, in particular by means of the (same) drive apparatus 233.

Mostly preferred, both, the clamping unit 232 and the intermediate unit 230, are guided by the (common) guide apparatus 234, in particular by the first guide 234A and the second guide 234B.

Preferably, the intermediate unit 230 is guided on both sides in a tiltable manner and/or with an angular play, i.e. both guides 234A, 234B allow an angular movement of the intermediate unit 230, said movement already explained in the context of the clamping unit 232 for the second guide 234B.

In particular, also the first rail 234C is tiltable relative to the intermediate unit 230 and/or also the first guide 234A allows tilting of the intermediate unit 230 relative to the clamping unit 232, the connection unit 231 and/or the rails 234C, 234D.

In other words, the guide apparatus 234 preferably allows angular movement at both guides 234A, 234B for the intermediate unit 230, whereas for the clamping unit 232 such movement is preferably only possible at the second guide 234B.

The guide apparatus 234 preferably comprises additional bushes 234N, 234O for the guidance of the intermediate unit 230, preferably wherein the bushes 234N, 234O for the intermediate unit 230 are axially spaced apart from the bushes 234E, 234F for the clamping unit 232.

Mostly preferred, the guide apparatus 234, in particular the first guide 234A, comprises a third bush 234N and/or the guide apparatus 234, in particular the second guide 234B, comprises a fourth bush 234O, preferably wherein the bushes 234N, 234O are attached to the intermediate unit 230, in particular to corresponding bearing portions 230A thereof.

The bushes 234N, 234O are preferably embodied as compensation bushes and/or similarly constructed to the compensation bush 234F which has been described with reference to the guidance of the clamping unit 232. In particular, the bushes 234N, 234O are embodied as spherical bearings and/or comprise one or several features of the compensation bush 234F. Preferably, the bushes 234N, 234O each comprises an inner part 234J, an outer part 234K and/or a securing part 234L.

The third bush 234N, in particular its outer part 234K, is attached to the intermediate unit 230, in particular its associated bearing portion 230A, preferably rigidly/immovably and/or in an axial and radial fixed/immovable manner and/or without axial and radial play.

The forth bush 234O, in particular its outer part 234K, is preferably only axially and/or vertically immovable attached to the intermediate unit 230, in particular its associated bearing portion 230A, similar to the compensation bush 234F for the clamping unit 232.

Preferably, the forth bush 234O is radially, in particular horizontally, movable within and/or (radially) float-mounted to the intermediate unit 230 and/or its associated bearing portion 230A.

Preferably, the analyzer 200, preferably the clamping system 280, mostly preferred the guide apparatus 234 and/or the intermediate unit 230, comprises/provides (also) a (single-side) radial play E (for the intermediate unit 230), as already explained in the context of the clamping unit 232.

Optionally, the analyzer 200, in particular the guide apparatus 234, (also) comprises a bearing part 234M for holding the forth bush 234O and/or for connecting the forth bush 234O to the intermediate unit 230, preferably with the horizontal play E.

In this way, corresponding advantages can be achieved.

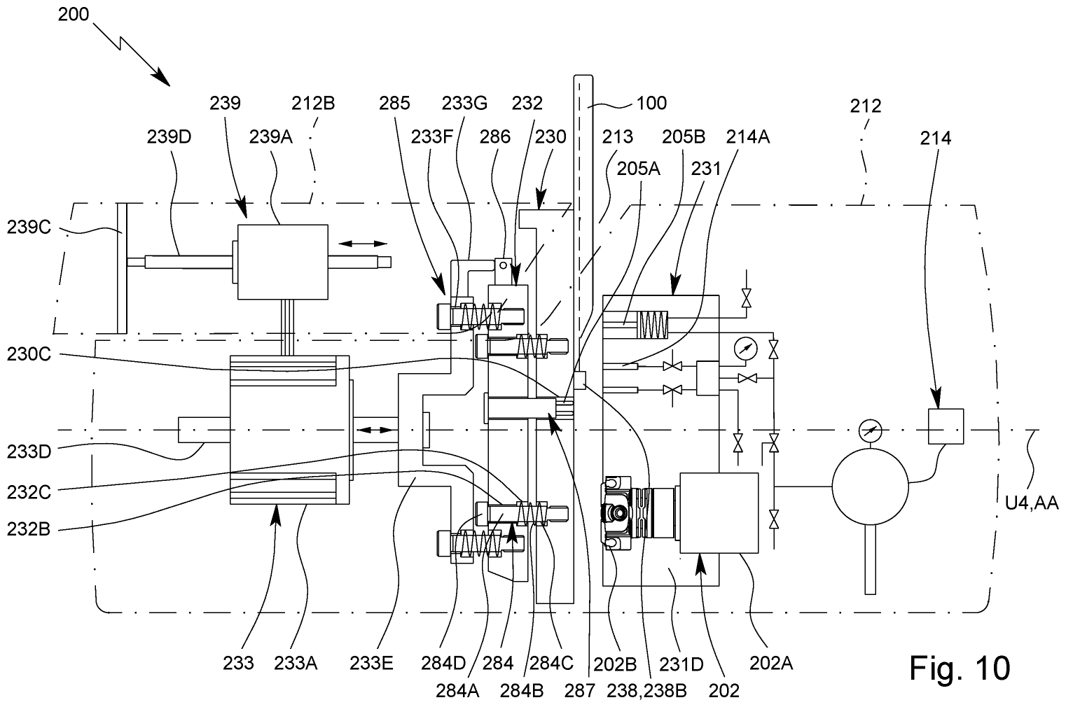

In the following the closing (and opening) mechanism/method of the analyzer 200 will be described with reference to FIGS. 10 to 14.

The closing (and opening) mechanism/method of the analyzer 200 is preferably conducted by means of the clamping system 280 and/or preferably comprises the steps of opening the analyzer 200 and/or the housing 212, receiving the cartridge 100, positioning/aligning the cartridge 100, clamping the cartridge 100, releasing the cartridge 100 and ejecting the cartridge 100.

The cartridge 100 and/or the clamping system 280, in particular the clamping unit 232, the intermediate unit 230 and/or the lifting apparatus 238, preferably change(s) its/their position/state during the closing and/or opening mechanism/method, preferably by means of the (common) drive apparatus 233.

Alternatively, or additionally, it is also possible for the connection unit 231 to change its position/state during the closing and/or opening mechanism/method, as already described above.

In order to insert the cartridge 100 into the analyzer 200, the analyzer 200, in particular its housing 212, is preferably to be opened, in particular by means of the opening apparatus 239, as already mentioned.

The opening apparatus 239 is preferably adapted to open and/or close the analyzer 200, in particular the housing 212, mostly preferred by moving the access cover/housing part 212B.

The opening apparatus 239 preferably comprises an opening drive 239A, a shaft 239D and/or a preferably frame-like support 239C, which is also shown in FIG. 5.

The opening apparatus 239 is preferably embodied as a stepper-motor and/or comprises a preferably threaded spindle as shaft 239D.

The opening apparatus 239, in particular its shaft 239D, is preferably mechanically connected to the access cover/housing part 212B, in particular via the support 239C. Mostly preferred, the access cover/housing part 212B is mounted on the opening apparatus 239, in particular the support 239C, preferably in a form-fitting and/or force-fitting manner and/or by screwing.

The opening apparatus 239, in particular its drive 239A, is preferably (rigidly) attached to the clamping system 280 and/or rack 237.

By means of the opening apparatus 239, the access cover/housing part 212B can be moved preferably linearly and/or back and forth, in particular in order to open and close the analyzer 200, as indicated by arrows in FIGS. 10 to 14.

The optional intermediate unit 230 is preferably adapted to receive, position, orientate and/or hold the cartridge 100, in particular between the clamping unit 232 and the connection unit 231, at least when being in the initial position.

Preferably, the intermediate unit 230 comprises the lifting apparatus 238. Mostly preferred, the lifting apparatus 238 is integrated into the intermediate unit 230 and/or moved together with the intermediate unit 230.

The lifting apparatus 238 is preferably adapted to receive the cartridge 100 and/or to move the cartridge 100 into and/or out of the analyzer 200, in particular the clamping system 280 and/or the intermediate unit 230 and/or the clamping unit 232.

The receiving direction of the cartridge 100 and/or the lifting movement of the lifting apparatus 238 preferably extend(s) transversally, in particular perpendicularly, to the direction of the actuation/closing/opening movement of the clamping system 280, in particular the clamping unit 232 and/or the intermediate unit 230, and/or to the actuation axis AA.

The intermediate unit 230 is preferably adapted to (directly) press the cartridge 100 against the connection unit 231, which is used in particular to mechanically, electrically, thermally and/or fluidically connect the cartridge 100 to the analyzer 200.

The clamping unit 232 is preferably adapted to position/align, orientate and/or hold the intermediate unit 230. Mostly preferred, the clamping unit 232 is adapted to position/align, orientate and/or hold the cartridge 100 by means of the intermediate unit 230 that is arranged between the clamping unit 232 and the cartridge 100.

Thus, the clamping unit 232 preferably (primarily) acts on the cartridge 100 in an indirect manner and/or by means of the intermediate unit 230.

Additionally, and/or alternatively, the clamping unit 232 acts on the cartridge 100 in a direct manner Mostly preferred, the clamping unit 232 is adapted to (directly) actuate, in particular open, one or more valves 115A of the cartridge 100.

In particular, the clamping unit 232 comprises or forms the actuator(s) 205A for actuating, in particular opening, one or more valves 115A of the cartridge 100, as will be described later.

In the present embodiment, the clamping unit 232 acts both directly and indirectly, i.e. via the intermediate unit 230, on the cartridge 100. However, it is also possible that either the clamping unit 232 or the intermediate unit 230 solely acts on the cartridge 100 in a direct manner

FIG. 10 shows analyzer 200, i.e. its housing 212, in the open state/position, the clamping system 280, in particular the clamping unit 232 and/or the intermediate unit 230, in the initial position and the lifting apparatus 238 in the transfer position.

The open state/position of the analyzer 200 is preferably the position, in which the opening 213 is formed and/or the receptacle 201 is accessible and/or in which the lifting apparatus 238 is in the transfer position and/or in which the cartridge 100 can be inserted into and/or removed from the analyzer 200, in particular the clamping system 280, the intermediate unit 230, the lifting apparatus 238 and/or the receptacle 201.

The transfer position of the lifting apparatus 238 is preferably the position in which the lifting apparatus 238 is ready to receive a (new) cartridge 100 and/or to move a (new) cartridge 100 into the analyzer 200 and/or in which a (used) cartridge 100 is ejected or can be removed from the analyzer 200. Preferably, a retaining element 238B of the lifting apparatus 238 has been completely moved upwards in the transfer position of the lifting apparatus 238, in particular such that the cartridge 100 projects out of the analyzer 200 or its housing 212 or opening 213 and/or can be grabbed, as shown in FIG. 10.

The initial/receiving position of the clamping system 280, in particular the clamping unit 232 and/or the intermediate unit 230, is preferably the position, in which the lifting apparatus 238 can be used and/or in which the cartridge 100 can be inserted into and/or received by and/or ejected/removed from the clamping system 280, in particular the clamping unit 232 and/or the intermediate unit 230, mostly preferred by means of the lifting apparatus 238.

Preferably, the distance between the clamping unit 232 and/or the intermediate unit 230 on the one hand and the connection unit 231 on the other hand is maximized and/or the clamping unit 232 and/or the intermediate unit 230 are/is moved away from the connection unit 231 in the initial/receiving position.

Preferably, the intermediate unit 230 and/or the lifting apparatus 238 can be tilted in the initial position relative to the clamping unit 232 and/or connection unit 231, in particular due to the guide apparatus 234, as already explained.

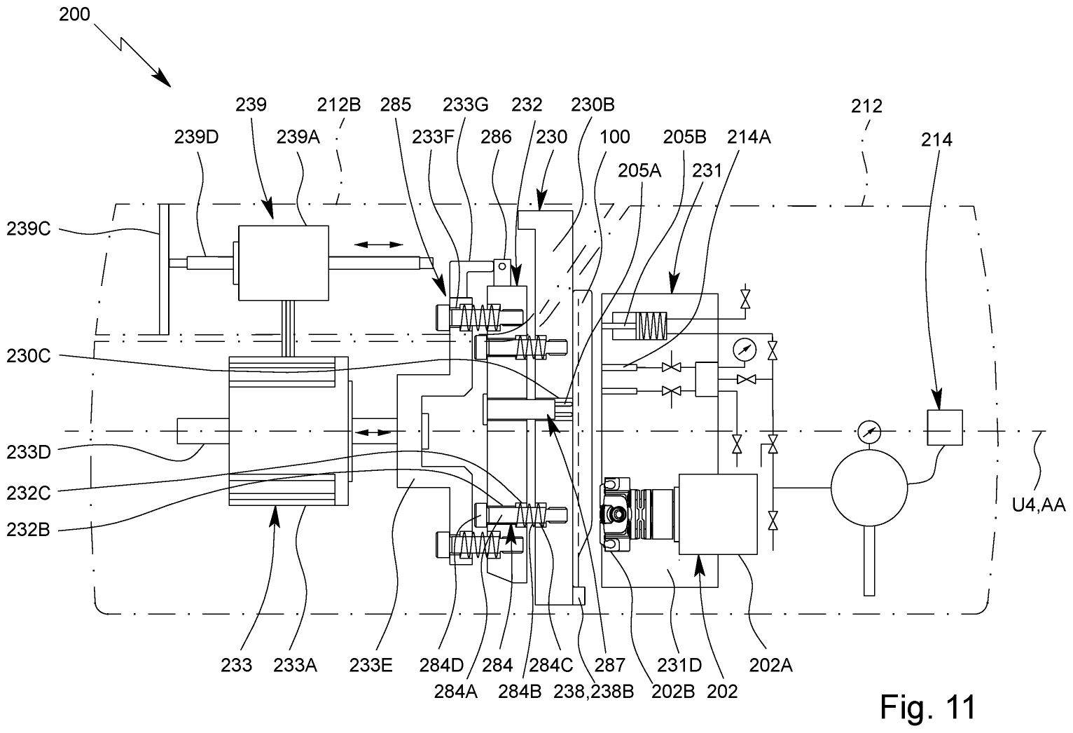

FIG. 11 corresponds to FIG. 10, but shows the lifting apparatus 238 in the end position. The housing 212 of the analyzer 200 is (already) closed. However, the clamping unit 232 and the intermediate unit 230 are (still) in the receiving/initial position.

The end position of the lifting apparatus 238 is preferably the position in which the lifting apparatus 238 has received/lowered the cartridge 100 completely. Preferably, the retaining element 238B of the lifting apparatus 238 has been completely moved downwards into the end position of the lifting apparatus 238, in particular such that the cartridge 100 does not project out of the analyzer 200 or its housing 212 or opening 213 and/or that the analyzer 200, in particular its housing 212, can be closed without interfering with the cartridge 100.

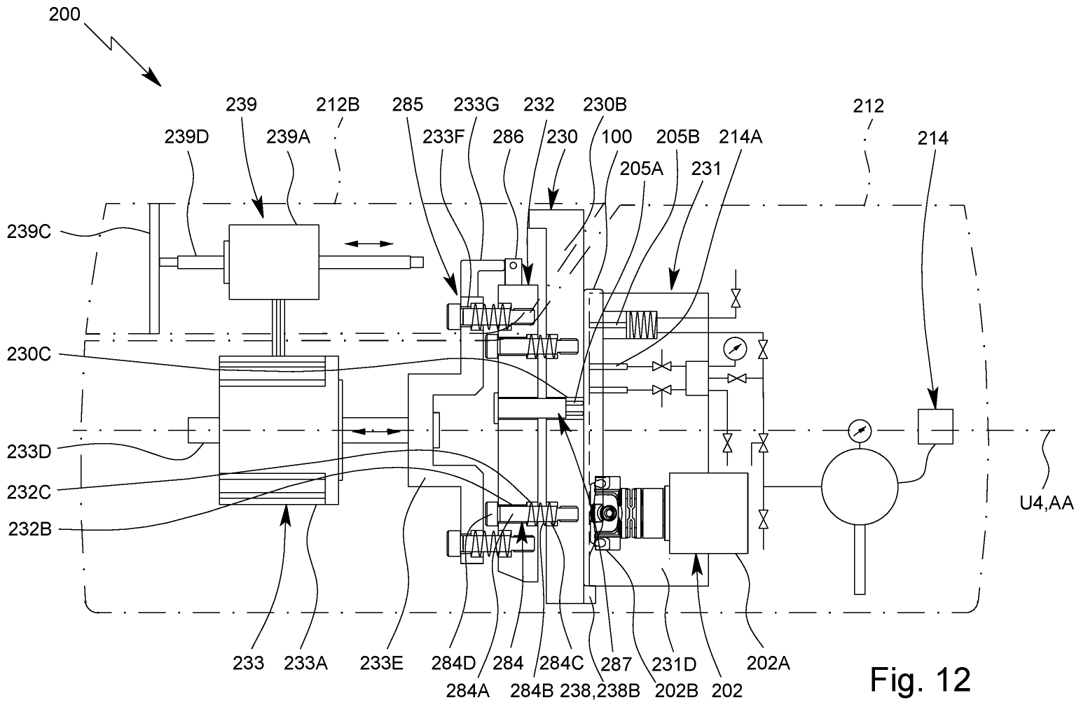

FIG. 12 corresponds to FIG. 11, but shows the clamping system 280 in the clamping position.

Preferably, the clamping position follows the initial position.

The clamping position is the position in which the clamping unit 232, the intermediate unit 230 and the cartridge 100 have been moved together towards the connection unit 231. In particular, the clamping unit 232 and the intermediate unit 230 have been moved out of the initial position towards the connection unit 231 until the cartridge 100 is clamped between the clamping unit 232 and/or the intermediate unit 230 on the one hand and the connection unit 231 on the other hand.

The clamping position of the clamping system 280, in particular the clamping unit 232 and/or the intermediate unit 230, is preferably the position, in which the intermediate unit 230 abuts and/or is completely moved towards and/or pressed against the cartridge 100 and/or in which the cartridge 100 abuts and/or is completely moved towards and/or positioned/pressed against the connection unit 231.

Preferably, the cartridge 100 is immovably held between the clamping unit 232 and/or the intermediate unit 230 on the one hand and the connection unit 231 on the other hand in the clamping position. Mostly preferred, the distance between the intermediate unit 230 and the connection unit 231 is minimized in the clamping position.

Preferably, the distances between the drive head 233E, the clamping unit 232 and/or the intermediate unit 230 is unchanged in the clamping position compared to the initial position. With other words, the drive head 233E, the clamping unit 232 and/or the intermediate unit 230 preferably have not been moved relative to one another when the clamping position has been reached.

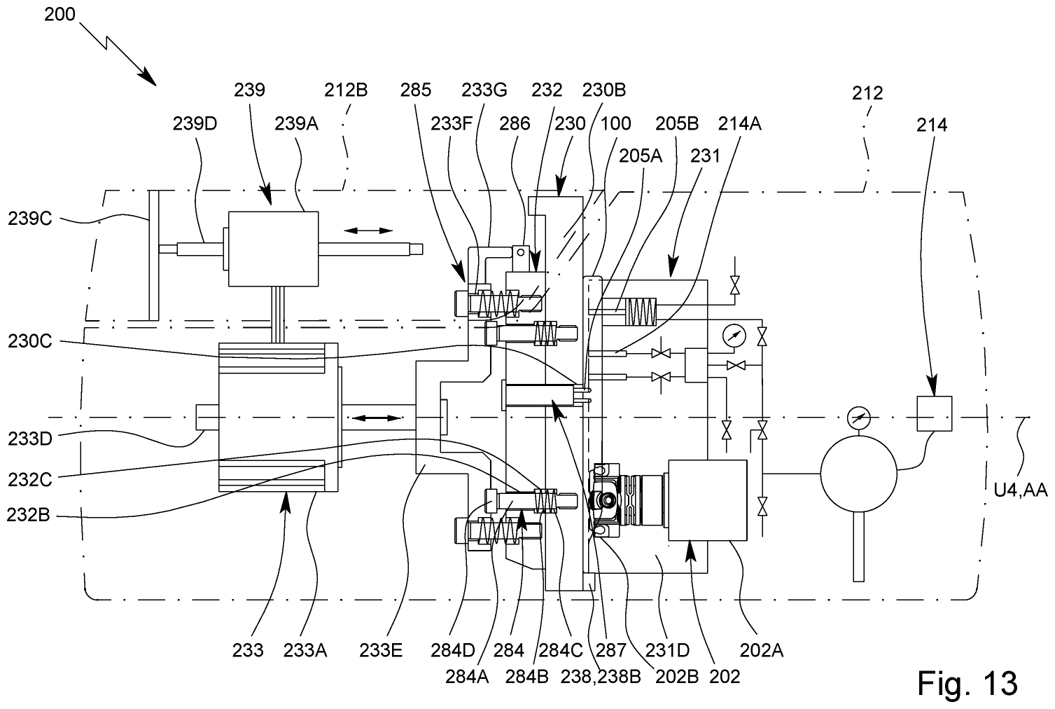

FIG. 13 corresponds to FIG. 12, but shows the clamping system 280 in the actuated position.

The actuated position preferably follows the clamping position. Preferably, the (horizontal) position of the intermediate unit 230 is unchanged in the actuated position compared to the clamping position and/or only the (horizontal) position of the drive head 233E and/or the clamping unit 232 is different in the actuated position compared to the clamping position.

The optional actuated position of the clamping system 280, in particular the clamping unit 232 and/or the intermediate unit 230, is preferably the position, in which the distance between the clamping unit 232 and the intermediate unit 230 is minimized and/or in which the clamping unit 232 is completely moved towards and/or abuts the intermediate unit 230.

Mostly preferred, a plurality or all of the (initially closed) valves 115A of the cartridge 100 are actuated, in particular forced open, preferably by means of the clamping unit 232 and/or one or more actuators 205A in the actuated position and/or when the actuated position is reached.

Thus, the clamping unit 232 is preferably used for moving the intermediate unit 230 relative to the connection unit 231, in particular in order to position, place or clamp the cartridge 100 on the connection unit 231, and/or for actuating or opening one or more valves 115A of the cartridge 100.

Preferably, the clamping unit 232 and the intermediate unit 230 can be moved together in the first period of movement or first step and can be moved relative to one another in the movement direction in the second period of movement or second step, in particular in order to move the cartridge 100 towards the connection unit 231 and in particular also in order to open one or more valves 115A.

Mostly preferred, the intermediate unit 230 is (completely) positioned and/or aligned in the actuated position, in particular relative to and/or by means of the clamping unit 232.

The force exerted on the cartridge 100 is preferably larger in the actuated position than in the clamping position.

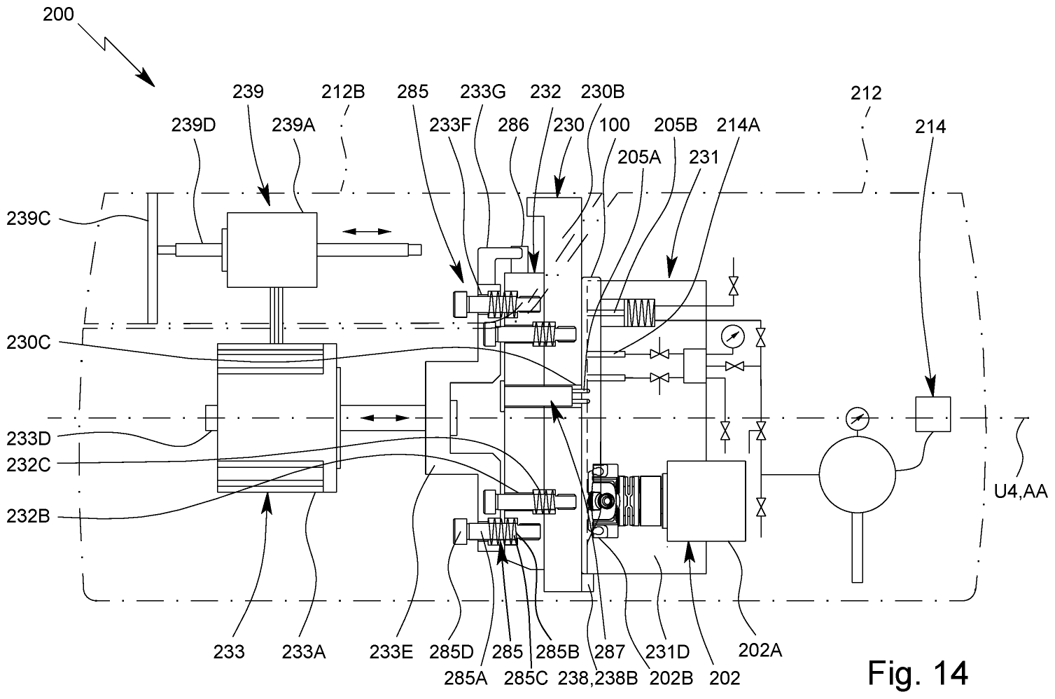

FIG. 14 corresponds to FIG. 13, but shows the clamping system 280 in the test position.

The test position preferably follows the actuated position. Preferably, the position of the clamping unit 232 and/or intermediate unit 230 is unchanged in the test position compared to the actuated position and/or only the position of the drive head 233E is different in the test position compared to the actuated position.

Preferably, the force exerted on the cartridge 100 is larger in the test position than in the actuated position and/or the clamping position.

The test position of the clamping system 280, in particular the clamping unit 232 and/or the intermediate unit 230, is preferably the final position and/or the position, in which the distance between the drive head 233E of the drive apparatus 233 and the clamping unit 232 is minimized and/or in which the drive head 233E is completely moved towards and/or abuts the clamping unit 232 and/or in which the force exerted on the cartridge 100 is maximized

Preferably, the test can (only) be conducted, when the test position is reached.

The intermediate unit 230 and/or the clamping unit 232 can preferably be moved out of the initial position into the clamping position, actuated position and/or test position or vice versa by means of the drive apparatus 233.

Once the cartridge 100 has been received and/or the lifting apparatus 238 is in the end position, the cartridge 100, the clamping unit 232 and/or the intermediate unit 230 containing the cartridge 100 are/is moved, in particular pushed, in a first step/period of movement, preferably towards the connection unit 231, in particular until the cartridge 100 abuts the connection unit 231 and/or is positioned on or against the connection unit 231 in the desired manner and/or until the cartridge 100 is clamped between the connection unit 231 and the intermediate unit 230 in the desired manner and/or until the clamping position has been reached.

In the clamping position, the clamping unit 232 has preferably not yet been moved relative to the intermediate unit 230 and/or the cartridge 100, but has preferably already been moved relative to the connection unit 231, in particular together with the intermediate unit 230 and/or the cartridge 100.

As already mentioned, the clamping unit 232, the intermediate unit 230 and/or the drive apparatus 233, in particular its drive head 233E, are preferably mechanically connected/coupled to one another and/or moved together, at least until the clamping position is reached.

The analyzer 200, in particular the clamping system 280, preferably comprises a first coupling/connection 284 for mechanically connecting the clamping unit 232 and the intermediate unit 230 to one another and an optional second coupling/connection 285 for mechanically connecting the clamping unit 232 and the drive head 233E to one another.

The first coupling 284 is preferably arranged between the clamping unit 232 and the intermediate unit 230.

The second coupling 285 is preferably arranged or acts between the drive head 233E and the clamping unit 232.

Thus, the couplings 284, 285 are preferably arranged in series.

Preferably, the first coupling 284 is flexible/yieldable/compressible, in particular in the direction of actuation.

The first coupling 284 preferably comprises at least one coupling element 284A and/or at least one coupling spring 284B, preferably wherein the coupling element 284A is embodied as a screw, in particular a fitting screw, and/or wherein the coupling spring 284B is embodied as a coil and/or helical spring and/or arranged around the coupling element 284A.

The first coupling 284 preferably allows a movement of the clamping unit 232 and the intermediate unit 230 towards each other and/or limits the movement/distance between the clamping unit 232 and the intermediate unit 230.

The first coupling 284, in particular its coupling element 284A, is preferably rigidly/immovably attached to the intermediate unit 230 on one end and (axially) movably connected to the clamping unit 232 on the other end, or vice versa.

In the present embodiment, the first coupling 284, in particular its coupling element 284A, is preferably screwed into the intermediate unit 230 and axially movably connected to and/or held by the clamping unit 232. However, other solutions are possible as well. For example, the first coupling 284, in particular the coupling element 284A, might be rigidly/immovably connected to the clamping unit 232 and movably connected to the intermediate unit 230.

Preferably, the clamping unit 232 comprises an opening 232B, preferably wherein the first coupling 284, in particular its coupling element 284A, extends through the opening 232B and/or from one side of the clamping unit 232 to the other side of the clamping unit 232.

The coupling element 284A preferably comprises a shaft 284C and a head 284D, preferably wherein the shaft 284B extends through the opening 232B of the clamping unit 232.

The head 284D is preferably wider or has a larger diameter than the shaft 284C and/or the opening 232B.

The first coupling 284 is preferably connected to the clamping unit 232 in a form-fitting manner, in particular by means of the coupling element 284A, in particular its head 284D, and/or at least in an axial direction.

The head 284D is preferably arranged on a side of the clamping unit 232 facing the drive apparatus 233 and/or opposite to the side of the clamping unit 232 facing the intermediate unit 230.

Mostly preferred, the head 284D abuts the clamping unit 232, in particular its flat side facing the drive apparatus 233, at least in the initial position and/or clamping position. In this way, the distance between the clamping unit 232 and the intermediate unit 230 is adjusted and/or limited to a predefined maximum value.

When the head 284D abuts the clamping unit 232, the clamping unit 232 and the intermediate unit 230 cannot be moved further away from each other. In this way, the drive apparatus 233 can move the clamping unit 232 and the intermediate unit 230 away from the connection unit 231, in particular without stressing the coupling spring 284B and/or in a predefined manner

Due to the first coupling 284, the clamping unit 232 can preferably be moved towards and/or in the direction of the intermediate unit 230 after the clamping position has been reached and/or when changing from the clamping position to the actuated position and/or test position, in particular by compressing the coupling spring 284B and/or against the spring force of the coupling spring 284B.

Preferably, when the clamping position has been reached and/or when changing from the clamping position to the actuated position and/or test position, the clamping unit 232 is moved away from the head 284D, in particular due to the compression of the spring 284B, such that the head 284D no longer abuts the clamping unit 232.

Further, the clamping unit 232 and the intermediate unit 230 can be moved back and/or away from the connection unit 231 due to the first coupling 284, in particular the coupling element 284A.

The coupling spring 284B is preferably pretensioned, in particular (also) in the initial position.

When the clamping position has been reached, the cartridge 100 preferably abuts both, the connection unit 231 and the intermediate unit 230. Thus, in the clamping position the intermediate unit 230 preferably cannot be moved further towards the connection unit 231.

After the clamping position has been reached, the clamping unit 232 is preferably further actuated and/or moved towards the intermediate unit 230, the cartridge 100 and/or the connection unit 231, in particular against the spring force of the first coupling 284, in particular its coupling spring 284B, and/or against the spring force of the optional second coupling 285.

Thus, it is preferred, that (only) the clamping unit 232 is moved towards the intermediate unit 230 and the connection unit 231—in particular by means of the drive apparatus 233—after the clamping position has been reached and/or when changing from the clamping position to the actuated position and/or in the next/second step/period of movement and/or of the closing mechanism/method.

The purpose of the second movement/step is in particular to actuate or open preferably a plurality of valves 115A of the cartridge 100. However, the clamping unit 232 can, alternatively or additionally, also be used for other purposes or forms of actuation and/or can be used to connect the cartridge 100 in further or other ways.

One end of the coupling spring 284B is preferably supported on or coupled to the intermediate unit 230 and the other end of the coupling spring 284B is supported on or coupled to the clamping unit 232.

Optionally, the clamping unit 232 and/or the intermediate unit 230 comprise/comprises a recess 232C for (supporting) the coupling spring 284B and/or in order to—partially or completely receive/hold/bear the coupling spring 284B, in particular when the coupling spring 284B is (further) compressed and/or such that the clamping unit 232 can abut the intermediate unit 230 in the actuated position.

The analyzer 200, in particular the clamping system 280, preferably comprises a plurality of first couplings 284, preferably wherein the plurality of first couplings 284 are arranged/connected in parallel and/or evenly distributed between the clamping unit 232 and the intermediate unit 230, in particular such that the force caused by the drive apparatus 233 is evenly distributed and/or exerted on the intermediate unit 230.

As already mentioned, the intermediate unit 230 is preferably guided in a tiltable/floating manner, in particular in order to compensate radial and/or angular misalignments.

Preferably, the intermediate unit 230 and the clamping unit 232 are positioned/orientated/aligned relative to one another when moving the clamping unit 232 into the actuated position and/or towards the intermediate unit 230.

Preferably, during a first part/period of the movement of the clamping unit 232 towards the intermediate unit 230, the clamping unit 232 and the intermediate unit 230 are positioned/aligned relative to one another, in particular such that a predefined position/alignment of the intermediate unit 230 is reached.

Preferably, during a second/subsequent part/period of the movement of the clamping unit 232 towards the intermediate unit 230 at least one of the initially closed valves 115A of the cartridge 100 is actuated, in particular opened, and mostly preferred in an automatic and/or forced manner

Thus, the movement of the clamping unit 232 and the intermediate unit 230 relative to one another and/or the movement into the actuated position preferably includes both, aligning/positioning the clamping unit 232 and the intermediate unit 230 relative to one another and actuating at least one of the initially closed valves 115A of the cartridge 100.

Mostly preferred, a plurality or all of the initially closed valves 115 that have to be actuated, in particular opened, for the test and/or that require a high actuation force are actuated, in particular opened, in a forced manner, mostly preferred by moving the clamping unit 232 and the intermediate unit 230 relative to one another and/or by means of the clamping unit 232.

The optional second coupling 285 is preferably similar to the first coupling 284, which has been described previously, and/or comprises one, several or all features of the first coupling 284.

The reference signs of the second coupling 285 are only shown in FIG. 14 for the sake of clarity.

Preferably, the second coupling 285 comprises a coupling element 285A and/or a coupling spring 285B.

Preferably, one end of the coupling spring 285B is supported on or coupled to the clamping unit 232 and the other end of the coupling spring 285B is supported on or coupled to the drive head 233E.

The coupling element 285A is preferably embodied as a screw, in particular a fitting screw, and/or comprises a shaft 285C and a head 285D.

The second coupling 285 is preferably connected to the drive head 233E in a form-fitting manner, in particular by means of the coupling element 285A, in particular its head 285D, and/or at least in an axial direction.

Preferably, the drive head 233E comprises an opening 233F, preferably wherein the coupling element 285A of the second coupling 285 is axially movably arranged within the opening 233F.

Preferably, (also) the second coupling 285 is flexible/yieldable/compressible, in particular in the direction of actuation and/or due to its coupling spring 285B.

Due to the second coupling 285, the drive head 233E can preferably be moved towards and/or in the direction of the clamping unit 232 after the actuated position has been reached and/or when changing from the actuated position to the test position, in particular by compressing the coupling spring 285B and/or against the spring force of the coupling spring 285B.

Further, the clamping unit 232 and/or the intermediate unit 230 can be moved back and/or away from the connection unit 231 by means of the drive head 233E, the first coupling 284, in particular its coupling element 284A, and/or the second coupling 285, in particular its coupling element 285A.

The second coupling 285 preferably allows to increase the force/pressure on the cartridge 100 in a controlled, defined and/or measured manner, in particular after the actuated position has been reached.

Preferably, the second coupling(s) 285, in particular its/their coupling spring(s) 285B, is/are stiffer/harder/stronger than the first coupling(s) 284, in particular its/their coupling spring(s) 284B, mostly preferred such that after the clamping position has been reached and/or when moving clamping unit 232 into the actuated position, the first coupling(s) 284, in particular its/their coupling spring(s) 284B, is/are deflected more strongly than the second coupling(s) 285, in particular its/their coupling spring(s) 285B, at least until the actuated positon is reached and/or until no further compression of the first coupling(s) 284, in particular its/their coupling spring(s) 284B, is possible.

With other words, preferably only the second coupling 285, in particular the coupling spring 285B, is (further) compressed after the actuated position has been reached and/or when moving the drive apparatus 233 from the actuated position into the test position.

The analyzer 200, in particular its clamping system 280, preferably comprises a plurality of second couplings 285, preferably wherein the second couplings 285 are arranged in parallel and/or evenly distributed between the drive apparatus 233, in particular its head 233E, and the clamping unit 232.

Due to the couplings 284, 285 it is possible to exert a pre-defined force on the cartridge 100 during the closing mechanism and/or to pull the clamping unit 232 and the intermediate unit 230 back and/or away from the connection unit 231, in particular into the initial position, after the test has been conducted.

The highest force/pressure is exerted on the cartridge 100 preferably in the test position.

The analyzer 200, in particular the clamping system 280, preferably comprises a detection apparatus 286, preferably wherein the detection apparatus 286 is adapted to detect the movement and/or position of the intermediate unit 230, the connection unit 231, the clamping unit 232 and/or the drive head 233E, in particular relative to one another, and/or if the clamping position, the actuated position and/or the test position has been reached.

Preferably, the detection apparatus 286 is adapted to detect the movement and/or position of the clamping unit 232 and the drive head 233E relative to one another and/or if the clamping unit 232 and/or the drive head 233E have/has reached the actuated position and/or test position.

Mostly preferred, the detection apparatus 286 is adapted to (directly) detect the compression of the second coupling 285, in particular its coupling spring 285D, and/or if a predefined spring deflection has been reached.

Preferably, the drive apparatus 233 is stopped by means of the detection apparatus 286 and/or when the detection apparatus 286 detects the test position.

In the present embodiment, the detection apparatus 286 is preferably adapted to (directly) detect a (predefined) spring deflection of the second coupling 285, in particular its coupling spring 285B. Alternatively or additionally, the detection apparatus 286 is adapted to detect a (predefined) spring deflection of the first coupling 284, in particular its coupling spring 284B.

The detection apparatus 286 is preferably embodied as a photoelectric sensor and/or comprises a transmitter, a receiver and an optional reflector.

However, other constructional solutions are possible as well, in particular wherein the detection apparatus 286 is embodied as a mechanical, electrical and/or electro-mechanical device/sensor.

The detection apparatus 286 is preferably rigidly/immovably attached to the clamping unit 232, in particular the top thereof, in particular to directly detect the (predefined) spring deflection. However, it is also possible that the detection apparatus 286 is attached to other parts of the analyzer 200, in particular the drive head 233E, the connection unit 231, the intermediate unit 230 and/or the rack 237.

Preferably, the drive apparatus 233, in particular its head 233E, triggers the detection apparatus 286 when the test position and/or a pre-defined spring deflection and/or a pre-defined force/pressure has been reached.

Preferably, the drive apparatus 233, in particular the drive head 233E, comprises or forms a trigger 233G, preferably wherein the trigger 233G is adapted to trigger the detection apparatus 286, in particular by interrupting the beam between the receiver and the transmitter of the detection apparatus 286.

Preferably, the trigger 233G is embodied as an at least essentially L-shaped and/or hook-like element/arm and/or projects out of the drive head 233E and/or in the direction of the clamping unit 232.

According to another preferred embodiment (not shown), the detection apparatus 286 is immovably arranged within the analyzer 200, in particular the clamping system 280, in order to detect the movement and/or (absolute) position of the clamping unit 232, the intermediate unit 230 and/or the drive apparatus 233, in particular its head 233E, and/or if the clamping position, the actuated position and/or the test position has been reached.

For example, the detection apparatus 286 might be attached to the rack 237.

Additionally or alternatively, the detection apparatus 286 or another detection apparatus might be attached to the intermediate unit 230 and/or the connection unit 231 in particular to detect if the clamping position, the actuated position and/or the test position has been reached.

As already mentioned, some or all of the (initially closed) valves 115A of the cartridge 100 are preferably actuated in an in particular mechanical manner and/or by means of the intermediate unit 230 and/or the clamping unit 232.

Preferably, the intermediate unit 230 and/or the clamping unit 232 mechanically act(s) on the cartridge 100 or valves 115A thereof by moving the intermediate unit 230 and/or the clamping unit 232 from the clamping position into the actuated position.

In the present embodiment, the clamping unit 232 preferably comprises or forms the actuators 205A for actuating the valves 115A. However, it is also possible, that the intermediate unit 230 and/or the connection unit 231 comprise(s) or form(s) some or all actuators 205A, additionally or alternatively, preferably wherein the valves 115A are actuated when the clamping unit 232 is moved relative to the intermediate unit 230.

The intermediate unit 230, in particular its main body 230B, preferably comprises a passage 230C, preferably wherein the actuators 205A engage through the passage 230C, at least in the actuated and/or test position.

The analyzer 200, in particular the clamping system 280, preferably comprises at least one actuation apparatus 287, preferably wherein the actuation apparatus 287 comprises at least one actuator 205A, preferably a plurality of actuators 205A.

The actuation apparatus 287 is preferably integrated into the clamping unit 232 or the intermediate unit 230.

Mostly preferred, the actuation apparatus 287 is rigidly attached to the clamping unit 232 and/or is moved together with the clamping unit 232.

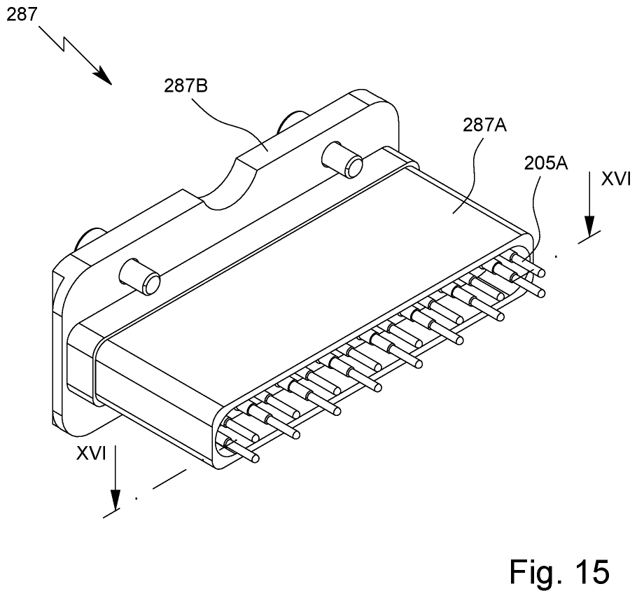

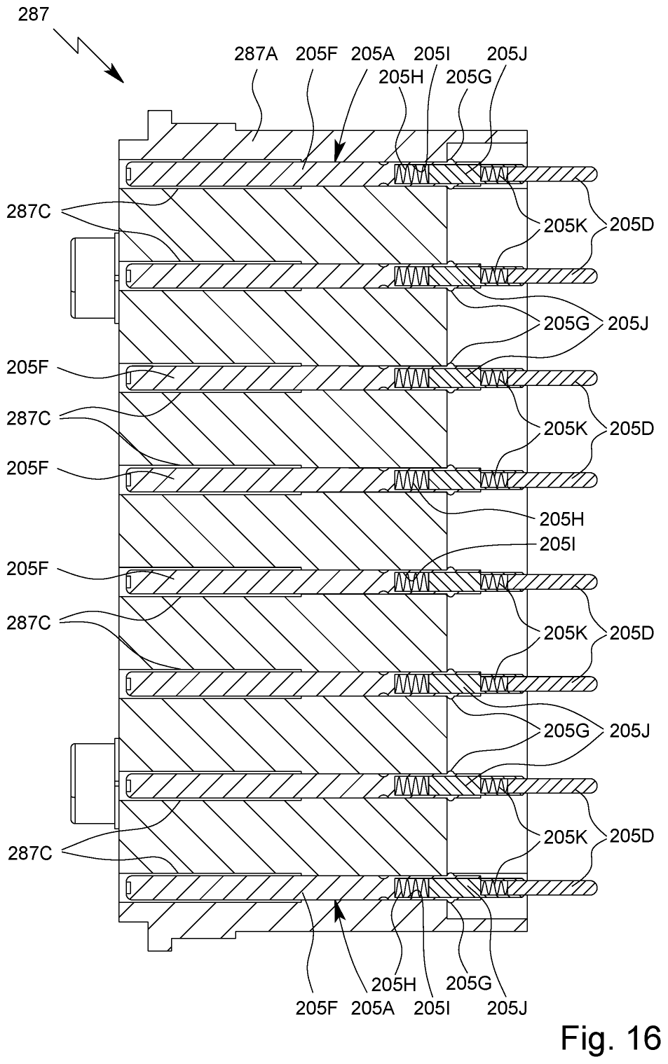

The construction of the actuation apparatus 287 and the actuators 205A will be described in the following with reference to FIGS. 15 and 16. FIG. 15 is a schematic perspective view of the actuation apparatus 287. FIG. 16 is a schematic section of the actuation apparatus 287 along the line XVI-XVI shown in FIG. 15.

The actuation apparatus 287 preferably comprises a mounting support 287A, preferably wherein at least one, in particular a plurality of actuators 205A, is mounted to the mounting support 287A.

The mounting support 287A is preferably formed integrally and/or as one piece.

Preferably, the mounting support 287A is made of plastic and/or injection molded.

The actuation apparatus 287 preferably comprises a flange 287B, preferably wherein the flange 287B and the mounting support 287A are formed integrally.

The flange 287B is preferably arranged on the side of the clamping unit 232 that is opposite to the intermediate unit 230 and/or faces the drive apparatus 233.

Preferably, the actuation apparatus 287 is rigidly attached to the clamping unit 232 by means of the flange 287B, in particular by screwing. However, other constructional solutions are possible as well, in particular wherein the clamping unit 232 or its main body 232D forms the mounting support 287A.

The actuation apparatus 287, in particular its mounting support 287A, preferably comprises or forms a plurality of receptacles 287C, preferably wherein, respectively, one actuator 205A is inserted into a corresponding receptacle 287C.

Preferably, the actuators 205A are connected to the actuation apparatus 287, in particular its mounting support 287A, in a form-fitting and/or force-fitting manner and/or by welding, in particular by inserting, mostly preferred press-fitting, the actuators 205A into the corresponding receptacles 287C.

The actuators 205A are preferably embodied as pins and/or pin-like/shaped.

Preferably, the actuators 205A are elongated and/or at least essentially cylindrical.

Mostly preferred, each actuator 205A comprises/defines a central/axial axis, preferably wherein the central/axial axes of the actuators 205A are at least essentially parallel to one another and/or to the actuation axis AA, the first guide axis AG1 and/or the second guide axis AG2 and/or at least essentially perpendicular to the main plane U1 of the intermediate unit 230, the main plane U2 of the connection unit 231, the main plan U3 of the clamping unit 232 and/or the main plane H of the cartridge 100.

Preferably, the actuators 205A project out of the clamping unit 232, in particular the actuation apparatus 287 or its mounting support 287A.

Each actuator 205A preferably comprises an actuation element 205D that is adapted to engage the cartridge 100, in particular a corresponding valve 115A.

Preferably, the actuation elements 205D comprise or form an axial end and/or a tip of the respective actuators 205A.

Each actuator 205A preferably comprises a main body 205F, preferably wherein the main body 205F is (immovably) connected to the mounting support 287A, preferably in a form-fitting and/or force-fitting manner and/or by welding, and/or wherein the main body 205F is at least partially inserted into the mounting support 287A and/or a corresponding receptacle 287C.

Each actuator 205A, in particular its main body 205F, preferably comprises or forms a preferably axial stop 205G, preferably wherein the stop 205G limits the insertion of the actuators 205A into the mounting support 287A and/or the receptacle 287C and/or provides an equal and/or pre-defined mounting depth.

Each stop 205G is preferably embodied as a preferably circumferential and/or radial bead on the outer surface of the actuators 205A, in particular its main body 205F.

The actuators 205A are preferably flexible, elastic and/or compressible, mostly preferred in an axial and/or radial direction and/or individually and/or independently from one another.

Preferably, the length of the actuators 205A can be (individually) reduced when a force is exerted on the respective actuation elements 205D of the actuators 205A, in particular against a spring force.

Preferably, each actuator 205A is embodied as a telescope and/or can be telescoped and/or compressed in a telescope-like manner, in particular against a spring force.

The actuation element 205D is preferably movably/slidably held by means of the main body 205F.

Mostly preferred, each actuator 205A or actuation element 205D is spring-mounted, preferably in the mounting support 287A or main body 205F. In the present embodiment, each actuation element 205D is spring-mounted in the main body 205F. However, it is also possible that each actuator 205A, in particular its main body 205F, is spring-mounted in the mounting support 287A additionally or alternatively.

The actuation apparatus 287, in particular each actuator 205A, preferably comprises at least one actuation spring 205H, preferably wherein the actuation spring 205H is arranged within the actuation apparatus 287, in particular the corresponding actuator 205A, and/or pushes the actuation element 205D out of the main body 205F of the actuator 205A.

With other words, each actuator 205A is preferably compressible by compressing its actuation spring 205H.

Each actuation spring 205H is preferably embodied as a helical/coil spring.

Each actuator 205A preferably comprises a receptacle 205I, preferably wherein the actuation spring 205H is arranged within the receptacle 205I, preferably in a pre-tensioned manner. Mostly preferred, the main body 205F comprises or forms the receptacle 205I.

Optionally, each actuator 205A comprises an intermediate element 205J and/or a second actuation spring 205K, preferably wherein the intermediate element 205J is arranged between the first actuation spring 205H and the second actuation spring 205K.

The actuators 205A are preferably arranged in pairs. Mostly preferred, two actuators 205A form a pair, that is associated to a corresponding valve 115A and/or that is adapted to actuated, in particular open, a corresponding valve 115A. Thus, one valve 115A is preferably actuated by two associated actuators 205A.

Mostly preferred, two vertically arranged actuators 205A and/or two actuators 205A that are arranged directly above one another form a pair, as shown in FIG. 15.

The actuation apparatus 287 preferably comprises a plurality of pairs. Preferably, some or all pairs of actuators 205A are arranged horizontally and/or in a (horizontal) row and/or directly next to each other.

The actuation apparatus 287 shown in FIGS. 15 and 16 comprises eight pairs of actuators 205A, i.e. 16 actuators 205A that are arranged in two (horizontal) rows.

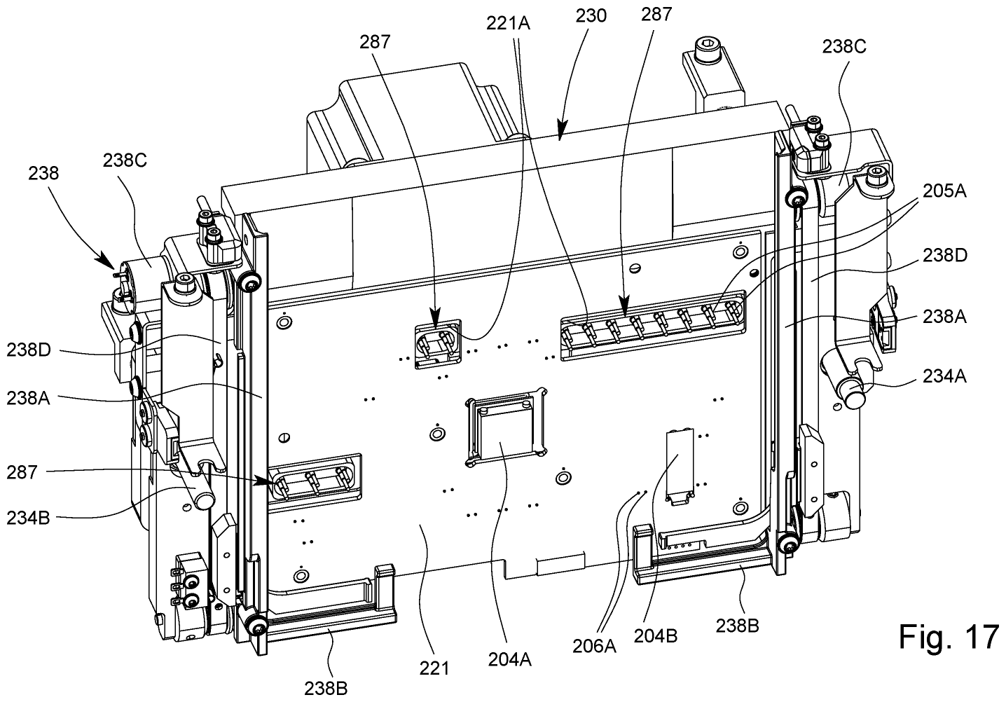

Preferably, the analyzer 200, in particular the clamping system 280, mostly preferred the clamping unit 232, comprises/holds a plurality of actuation apparatuses 287 for actuating different valves 115A and/or different sets of valves 115A on the cartridge 100. In the present embodiment, the analyzer 200 comprises three actuation apparatuses 287, as best seen in FIG. 17, which is a perspective view of the intermediate unit 230 of the analyzer 200 showing the front side of the intermediate unit 230.

The actuation apparatuses 287 are preferably spaced apart from one another.

The actuation apparatuses 287 and/or the actuators 205A are preferably moved together towards the connection unit 231 and/or intermediate unit 230 and/or cartridge 100 and/or driven by the (common) drive apparatus 233.

However, the analyzer 200, in particular the clamping unit 232 or the intermediate unit 230, preferably comprises at least one actuation apparatus 287 and/or actuators 205A that can be actuated independently of the movement of the intermediate unit 230 relative to the connection unit 231, independently of the movement of the clamping unit 232 towards the intermediate unit 230 and/or independently of one another. Such an actuation apparatus 287 and/or actuators 205A are shown in FIG. 17 on the left-hand side of the intermediate unit 230 or a printed circuit board 221 thereof in the form of three adjacent pairs of pins, and is/are used in particular for opening the valves 115A assigned to the receiving cavity 104 or other valves, as required. This actuation apparatus 287 and/or actuators 205A preferably comprise(s) separate drives (not shown) for individual actuation.

The intermediate unit 230, in particular the lifting apparatus 238, preferably comprises a lateral, in particular groove-like guide 238A and/or a retaining element 238B, preferably wherein the guide 238A and the retaining element 238B comprise or form the receptacle 201 for the cartridge 100.

The guide 238 is preferably designed to guide the cartridge 100 laterally.

The lifting apparatus 238, in particular the retaining element 238B, is preferably designed to hold the cartridge 100 from below and to move the cartridge 100 up and down by moving the retaining element 238B correspondingly.

In the present embodiment the intermediate unit 230, in particular the lifting apparatus 238, preferably comprises a plurality, here two, retaining elements 238B, preferably wherein the retaining elements 238B are arranged on both sides of the intermediate unit 230 and/or lifting apparatus 238.

FIG. 17 shows the lowered position of the retaining element 238B. In this position, the entire cartridge 100 is received and, thus, the lifting apparatus is in its end position, as already explained with reference to FIGS. 10 to 14.

The lifting apparatus preferably comprises a drive 238C and/or belt 238D, preferably wherein the lifting apparatus 238, in particular its belt 238D, is driven by means of the drive 238C.

The retaining element 238B is preferably rigidly attached to the belt 238D, in particular in a form-fitting and/or force-fitting manner and/or by screwing.

In the present embodiment, the lifting apparatus 238 preferably comprises two belts 238D and two drives 238C, preferably wherein the belts 238D and drives 238C are arranged on both sides of the lifting apparatus 238 and/or intermediate unit 230. Preferably, one retaining element 238B is attached to a corresponding belt 238D.

The intermediate unit 230 preferably comprises a contact surface for the cartridge 100, in particular its front 100A or cover 102, that is at least substantially planar, flat and/or continuous, in particular in order to support the cartridge 100 in the clamping/actuated/test position, mostly preferred as evenly as possible and/or over the largest possible surface area and/or in order to hold and/or clamp the cartridge 100 against the connection unit 231.

The intermediate unit 230 preferably comprises or holds a printed circuit board 221, preferably wherein the printed circuit board 221 forms or comprises the contact/support surface for the cartridge 100.

The printed circuit board 221 is preferably rigidly connected or fixed to the intermediate unit 230 and/or comprises recesses 221A that correspond to the passages 230C and/or through which the actuation apparatus(es) 287 and/or the actuator(s) 205A can act on the cartridge 100, as already explained.

A printed circuit board (PCB) is preferably a support/mount for electronic components, in particular with the purpose to mechanically mount and/or electrically connect these electronic components.

Typically, a printed circuit board comprises a flat or planar element of an electrically isolating material with conductive paths or tracks being arranged thereon. In particular, electronic components can be attached to the printed circuit board, e.g., by soldering, and/or can be electrically connected with each other by means of the conductive paths.

The intermediate unit 230 or printed circuit board 221 preferably comprises, holds or supports one or more temperature-control apparatuses 204, in particular the reaction temperature-control apparatus 204A and/or the intermediate temperature-control apparatus 204B.

In particular, the temperature-control apparatuses 204 are generally electrically operated Peltier elements.

The thermal contact surfaces of the temperature-control apparatuses 204 are in particular at least substantially in the plane of the contact surface or on the flat side of the printed circuit board 221 that faces the cartridge 100 and/or the connection unit 231.

The intermediate unit 230 or printed circuit board 221 preferably comprises or supports the fluid sensors 206A, in particular to detect flow fronts of fluids in the cartridge 100, preferably in the assigned sensor portions 116, as already explained.

Preferably, the printed circuit board 221 has, on the side facing away from the cartridge 100 and/or connection unit 231 (not visible in FIG. 17), all of the electrical components required for controlling the temperature-control apparatuses 204 and/or the fluid sensors 206A.

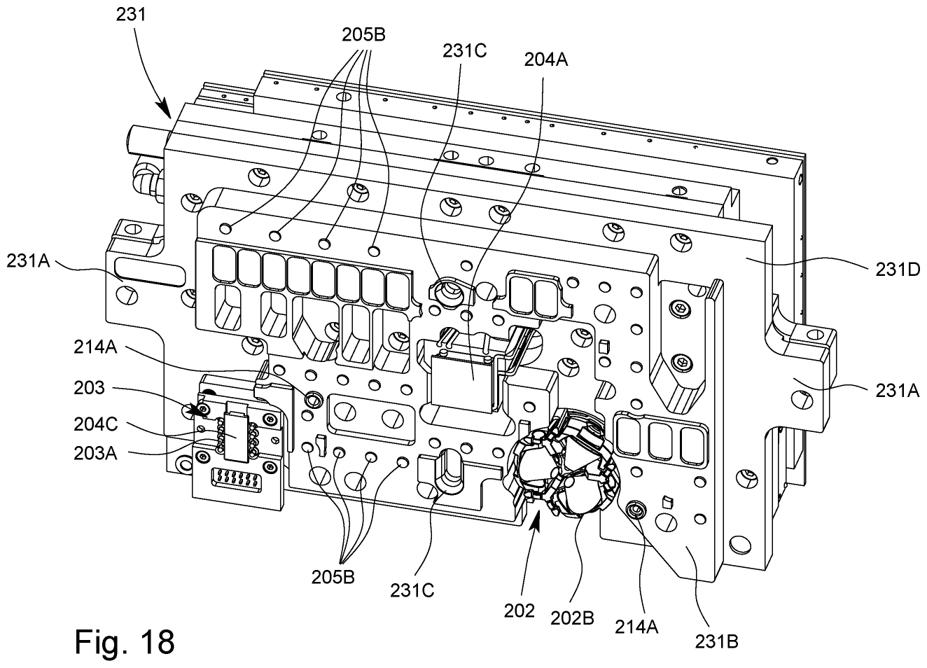

FIG. 18 is a perspective view of the connection unit 231.

The connection unit 231 preferably forms an abutment or a contact surface for the cartridge, in particular its back 100B.

Preferably, the connection unit 231 comprises/forms a corresponding contact surface or support region 231B that supports the cartridge 100 in the clamped position, actuated position and/or test position.

The cartridge 100 is preferably positioned/orientated in a defined manner in the clamped position, actuated position and/or test position. This can be achieved in particular by means of corresponding engagement with the intermediate unit 230 and/or the connection unit 231.

In the example shown, the connection unit 231 preferably comprises at least one engagement portion 231C, which is designed in particular as a recess or depression, in order to receive an associated positioning portion 126 of the cartridge 100 in the clamped position, actuated position and/or test position and to thereby position the cartridge 100 in its main plane H.

Particularly preferably, two engagement portions 231C are formed on the connection unit 231 that interact with the two positioning portions 126 of the cartridge 100 and/or engage in or with the two positioning portions 126 in the clamped position, actuated position and/or test position.

Particularly preferably, one engagement portion 231C, in this case the lower engagement portion 231C, is in the form of a slot or an oblong hole, whereas the other, in this case the upper, engagement portion 231C, is in the form of a circular hole. This provides for optimum positioning, reducing the risk of canting/jamming

The connection unit 231 preferably comprises (lateral) bearing portions 231A for the guide apparatus 234, in particular for receiving or bearing the guide apparatus 234, in particular the first rail 234C and the second rail 234D.

The connection unit 231 holds or comprises preferably one or more temperature-control apparatuses 204, in this case in particular a (further) reaction temperature-control apparatus 204A and/or the sensor temperature-control apparatus 204C.

The reaction temperature-control apparatus 204A of the connection unit 231 is preferably opposite the reaction temperature-control apparatus 204A of the intermediate unit 230.

Thus, the cartridge 100 and/or one or more reaction cavities 109 thereof are preferably received, arranged and/or clamped between said two temperature-control apparatuses 204A, in particular such that the temperature-control apparatuses 204A are positioned against or abut the cartridge 100 from opposing sides in the region of the reaction cavity/cavities 109.

This allows the reaction cavity/cavities 109 to be temperature-controlled in an optimal manner

However, also other solutions are possible here, in which only one reaction temperature-control apparatus 204A is provided either on the intermediate unit 230 or the connection unit 231.

One of the two temperature-control apparatuses 204A is preferably floatingly mounted and/or resiliently preloaded such that it is ensured that the temperature-control apparatuses 204A are positioned against the cartridge 100 in an effective and/or reliable manner and/or over the entire surface thereof and, thus, good thermal coupling is also ensured.

In particular, the temperature-control apparatus 204A of the connection unit 231 protrudes towards the cartridge 100 such that the temperature-control apparatus 204A engages in the recess, depression or region 101E of reduced wall thickness of the cartridge 100. The reduction in wall thickness of the main body 101 in the region of the reaction cavity/cavities 109 is advantageous in that it allows improved thermal coupling and/or reduces the thermal resistance between the temperature-control apparatus 204A and a fluid in the reaction cavity 109.

The reaction cavities 109 also preferably have a very small cross section perpendicularly to the main plane H, i.e. the cross section of said cavities is very flat and said cavities have a surface extension that is at least substantially parallel to the main plane H, and therefore the depth of said cavities 109 is low perpendicularly to the main plane H. This allows good thermal coupling between the fluid in the reaction cavities 109 and the temperature-control apparatuses 204A.

The sensor temperature-control apparatus 204C shown in FIG. 18 is preferably arranged and/or preferably projects such that, in the clamped/actuated/test position, the sensor apparatus 113 and/or a central region 113H between the contacts 113E is positioned against or abuts the sensor temperature-control apparatus 204C. This produces a thermal coupling in order to temperature-control, in the desired manner, a sensor compartment and fluids located therein and reactions, in particular such that heat is transferred from the sensor temperature-control apparatus 204C through the sensor apparatus 113 to a sensor compartment and fluids located therein, or vice versa.

The connection apparatuses 203 or the contact elements 203A thereof are arranged in particular around the temperature-control apparatus 204C in order to electrically connect or contact the sensor apparatus 113 or the contacts 113E thereof.

The connection unit 231 preferably supports one, a plurality of or all of the actuators 205B for actuating the assigned (normally open) valves 115B of the cartridge 100. FIGS. 10 to 14 schematically show an actuator 205B of this kind. It can be seen from FIG. 18 that preferably a plurality of actuators 205B are provided that can act on the cartridge 100 as required.

The actuators 205B are integrated in particular in a main body 231D of the connection unit 231. In the example shown, the main body 231D is preferably constructed or assembled from a plurality of plates or plate-shaped components.

The connection unit 231 preferably supports or holds the pump drive 202. In particular, the pump drive 202 is also integrated in the main body 231D, as shown in FIGS. 10 to 14 and 18.

In particular, a motor 202A of the pump drive 202 drives a pump head 202B of the pump drive 202.

The pump drive 202 and/or pump head 202B points towards the cartridge 100 and/or towards the intermediate unit 230, and therefore the pump head 202B can act on the pump apparatus 112 of the cartridge 100 in the desired manner in the test position. In particular, a fluid (gas or liquid) can be conveyed in the pump apparatus 112 and, thus, in the cartridge 100 by rotating the pump head 202B. The pumping is thus controlled by operating the pump drive 202 and/or pump motor 202A accordingly.

The connection unit 231 also preferably comprises at least one connection element 214A, in this case two connection elements 214A, of the pressurized gas supply 214. The connection element 214A projects in particular in the manner of a tube and/or is or can be fluidically connected in the clamping/actuated/test position to an associated connection 129 of the cartridge 100.

The pump drive 202 or the pump motor 202A thereof and the temperature-control apparatuses 204 are preferably operated electrically and in particular supplied with electrical power by the power supply 211 and/or controlled by the control apparatus 207.

Preferably, a plurality of apparatuses of the analyzer 200, such as the actuators 205, and/or a plurality of apparatuses of the cartridge 100, such as the pump apparatus 112 and the sensor apparatus 113, are supplied by the pressurized gas supply 214 and/or controlled and/or operated by the control apparatus 207 by activating corresponding valves and correspondingly supplying pressurized gas or pressurized air from the pressurized gas supply 214.

Following a test, the measurement results are read out electrically from the sensor apparatus 113 and processed either in the analyzer 200 or an external device (not shown).

Following the test, the used cartridge 100 is preferably ejected automatically, in particular my means of the lifting apparatus 238.

In particular, the intermediate unit 230, clamping unit 231 and/or the drive head 233E, and thus preferably also the cartridge 100, are/is moved back from the test/actuated/clamping position, in particular by means of the drive apparatus 233, in particular its drive 233A.

Initially, in the ejection process, the drive head 233E is preferably moved away from the clamping unit 232 and/or out of the test position and/or into the actuated position, preferably along with (partial) relaxation of the second coupling 285 or its coupling spring 285B.

Subsequently, the clamping unit 232 is preferably moved away from the intermediate unit 230 and/or out of the test/actuated position and/or into the initial/clamping position. Alternatively, this can however occur at a later stage, e.g., after the intermediate unit 230 has been moved away from the connection unit 231 and has in particular reached the initial position.

However, it is preferable that the intermediate unit 230 is only moved away from the connection unit 231 or moved back into the initial position after the clamping unit 232 has assumed the clamping/initial position.

Thus, the intermediate unit 230 is preferably moved away from the connection unit 231 and/or out of the test/actuated/clamping position and/or into the initial position.

Subsequently, the analyzer 200 or the opening 213 opens. For this purpose, the access cover/housing port 212B is in particular moved by means of the opening apparatus 239.

The cartridge 100 can then be removed. In particular, the cartridge 100 is first ejected or moved out into the transfer position. This is carried out in particular by means of the lifting apparatus 238. The analyzer 200 is then (again) in the state shown in FIG. 10.

Finally, the used cartridge 100 can be manually removed from the transfer position and a new cartridge 100 (containing a new sample P) can be loaded for further testing.

If a new cartridge 100 has not been inserted or plugged in within a specified period of time, the analyzer 200 closes preferably automatically.

If a new cartridge 100 is inserted after the analyzer 200 has opened, the cartridge 100 is preferably moved automatically from the transfer position into the position in which it has been received in its entirety. For this purpose, the analyzer 200 preferably comprises a detection means for detecting whether a cartridge 100 has been received in part or inserted in part (not shown).

The analyzer 200 or the opening 213 closes in a preferably automatic manner and/or only if no object is present in the region of the opening 213. To this end, the analyzer 200 preferably comprises a detection means for detecting objects located in the region of the opening 213 (not shown), in particular such that, if there is an object in this region, the device is automatically blocked or prevented from closing.

For reasons of safety, the analyzer 200 preferably is closed before the drive apparatus 233 is actuated and/or before the intermediate unit 230 is moved into the clamping/actuated/test position and/or before the cartridge 100 is mounted, positioned and/or clamped.

Individual aspects and features of the present invention and individual method steps and/or method variants may be implemented independently from one another, but also in any desired combination and/or order.

In particular, the present invention relates also to any one of the following aspects which can be realized independently or in any combination, also in combination with any aspects described above or in the claims.

In particular, the present invention relates also to any one of the following aspects which can be realized independently or in any combination, also in combination with any aspects described above or in the claims:
1. Analyzer 200 for testing an in particular biological sample P,
wherein the analyzer 200 comprises a clamping unit 232 for clamping the cartridge 100 and a connection unit 231 for mechanically, electrically, thermally and/or fluidically connecting the cartridge 100 to the analyzer 200, and

wherein the clamping unit 232 and the connection unit 231 can be moved relative to one another in order to hold the cartridge 100 in a clamped manner between the clamping unit 232 and the connection unit 231,

characterized

in that the analyzer 200 comprises a guide apparatus 234 for guiding the clamping unit 232 and/or the connection unit 231, wherein the guide apparatus 234 is adapted to compensate radial and/or angular misalignment, and/or

in that the analyzer 200 comprises a rack 237 and a housing 212, wherein the rack 237 is supported by a cushion 283 within the housing 212, and/or

in that the clamping unit 232 comprises at least one compressible actuator 205A.
2. Analyzer according to aspect 1, characterized in that the analyzer 200, in particular the guide apparatus 234, comprises a preferably one-sided angular play and/or a preferably one-sided radial play for the clamping unit 232 and/or the connection unit 231 and/or in that the analyzer 200, in particular the guide apparatus 234, is adapted to allow a preferably one-sided tilting and/or a preferably one-sided radial movement of the clamping unit 232, the connection unit 231 and/or the guide apparatus 234, in particular its rails 234C, 234D, relative to one another.
3. Analyzer according to aspect 1 or 2, characterized in that the guide apparatus 234 comprises a first guide 234A having a movable main bush 234E and a second guide 234B having a movable compensation bush 234F.
4. Analyzer according to aspect 3, characterized in that the compensation bush 234F is float-mounted and/or mounted with a radial play to the clamping unit 232 and/or in that the compensation bush 234F is embodied as a spherical bearing.
5. Analyzer according to aspect 3 or 4, characterized in that the guides 234A, 234B each comprises a rail 234C, 234D that is rigidly attached to the connection unit 231.
6. Analyzer according to any one of the preceding aspects, characterized in that the analyzer 200 comprises a rack 237, wherein the guide apparatus 234, in particular its rails 234C, 234D, and/or the connection unit 231 are/is rigidly attached to the rack 237.
7. Analyzer according to any one of the preceding aspects, characterized in that the analyzer 200 comprises a housing 212, wherein the rack 237 is mounted to the housing 212 in a screwless-manner.
8. Analyzer according to any one of the preceding aspects, characterized in that the analyzer 200 comprises a cushion 283 for holding the rack 237 and/or the connection unit 231 within the housing 212, preferably wherein the cushion 283 is flexible and/or made of foam.
9. Analyzer according to any one of the preceding aspects, characterized in that the analyzer 200 comprises an intermediate unit 230 for receiving the cartridge 100, wherein the intermediate unit 230 is movably arranged between the clamping unit 232 and the connection unit 231.
10. Analyzer according to aspect 9, characterized in that the clamping unit 232 and the intermediate unit 230 are coupled to one another by at least one coupling spring 284B and/or in that the actuators 205A protrude through the intermediate unit 230, at least in an actuated position.
11. Analyzer according to any one of the preceding aspects, characterized in that the intermediate unit 230 is tiltably mounted on the guide apparatus 234, in particular to the first guide 234A and the second guide 234B and/or on both sides.
12. Analyzer according to any one of the preceding aspects, characterized in that the analyzer 200 comprises a drive apparatus 233 for moving the clamping unit 232 and/or the intermediate unite 230 relative to the connection unit 231, preferably wherein the drive apparatus 233 is rigidly attached to the rack 237.
13. Analyzer according to aspect 12, characterized in that the drive apparatus 233 comprises a stepper motor and/or a threaded spindle.
14. Analyzer according to aspect 12 or 13, characterized in that the drive apparatus 233 comprises a drive head 233E, wherein the drive head 233E is coupled to the clamping unit 232 via at least one coupling spring 285B.
15. Analyzer according to aspect 14, characterized in that the analyzer 200 comprises a detection apparatus 286 for detecting the movement and/or positon of the drive head 233E, in particular relative to the clamping unit 232 and/or intermediate unit 230, and/or for detecting the compression of the coupling spring 284B, 285B, preferably wherein the detection apparatus 286is attached to the clamping unit 232.

What is claimed is:

1. Analyzer for testing a biological sample, comprising
a clamping unit for clamping the cartridge and
a connection unit for at least one of mechanically, electrically, thermally and fluidically connecting the cartridge to the analyzer,
wherein the clamping unit and the connection unit are movable relative to one another in order to hold the cartridge in a clamped manner between the clamping unit and the connection unit, and
wherein at least one of the following features is provided:
a guide apparatus for guiding at least one of the clamping unit and the connection unit, the guide apparatus being adapted to compensate for at least one of radial and angular misalignment;
a rack and a housing, wherein the rack is supported by a cushion within the housing; or
the clamping unit comprises at least one compressible actuator.

2. Analyzer according to claim 1, wherein the guide apparatus is provided with at least one of angular play and radial play for at least one of the clamping unit and the connection unit.

3. Analyzer according to claim 1, wherein the guide apparatus is adapted to allow at least one of tilting and radial movement of at least one of the clamping unit, the connection unit and the guide apparatus relative to one another.

4. Analyzer according to claim 1, wherein the guide apparatus comprises a first guide and a second guide.

5. Analyzer according to claim 4, wherein the guides comprise a different at least one of radial play and angular play.

6. Analyzer according to claim 4, wherein the first guide comprises a movable main bush and wherein the second guide comprises a movable compensation bush, wherein the at least one of radial play and angular play of the compensation bush is greater than the at least one of radial play and angular play of the main bush.

7. Analyzer according to claim 6, wherein the compensation bush is at least one of float-mounted and mounted with a radial play relative to the clamping unit.

8. Analyzer according to claim 6, wherein the compensation bush is embodied as a spherical bearing.

9. Analyzer according to claim 4, wherein the guides each comprises a rail that is rigidly attached to the connection unit.

10. Analyzer according to claim 1, wherein at least one of the guide apparatus and the connection unit are rigidly attached to the rack.

11. Analyzer according to claim 1, wherein the rack is mounted to the housing in a screwless-manner.

12. Analyzer according to claim 1, wherein the cushion is flexible.

13. Analyzer according to claim 1, wherein the clamping unit comprises a plurality of actuators, wherein the actuators are compressible.

14. Analyzer according to claim 13, wherein each of the actuators is spring mounted or flexible in or transverse to the direction of actuation.

15. Analyzer according to claim 1, further comprising an intermediate unit for receiving the cartridge, wherein the intermediate unit is movably arranged between the clamping unit and the connection unit.

16. Analyzer according to claim 15, wherein the clamping unit and the intermediate unit are coupled to one another by at least one coupling spring.

17. Analyzer according to claim 15, wherein the actuators protrude through the intermediate unit, at least in an actuated position.

18. Analyzer according to claim 15, wherein the intermediate unit is tiltably mounted on the guide apparatus.

19. Analyzer according to claim 15, further comprising a drive apparatus for moving at least one of the clamping unit and the intermediate unit relative to the connection unit, and wherein the drive apparatus comprises a drive head that is coupled to the clamping unit via at least one coupling spring.

20. Analyzer according to claim 19, further comprising a detection apparatus for detecting at least one of the movement and position of the drive head, preferably wherein the detection apparatus is attached to the clamping unit.
